(19) United States
(12) Patent Application Publication
(10) Pub. No.: US 2026/0208671 A1
(43) Pub. Date: Jul. 23, 2026

(54) ILLUMINABLE VEHICLE SUNROOF

(71) Applicant: SAINT-GOBAIN SEKURIT FRANCE, THOUROTTE (FR)

(72) Inventors: Jean-Baptiste LAUDEREAU, AUBERVILLIERS (FR); Mathieu BERARD, AUBERVILLIERS (FR); Emmanuel MIMOUN, AUBERVILLIERS (FR); Stefan ALTMEYER, AUBERVILLIERS (FR)

(21) Appl. No.: 19/144,293

(22) PCT Filed: Dec. 26, 2023
(86) PCT No.: PCT/EP2023/087805

§ 371 Date: Jun. 27, 2025

(30) Foreign Application Priority Data
Dec. 28, 2022 (FR) FR2214599

(51) Int. Cl. B60Q 3/208; B32B 17/10; B60J 1/00; B60J 3/00; B60J 7/16; B60Q 3/62; F21V 8/00

(52) U.S. Cl. CPC B60Q 3/208; B32B 17/10036; B32B 17/10541; B32B 17/10651; B60J 1/001; B60J 3/007; B60J 7/1642; B60Q 3/62; G02B 6/005; B32B 2307/418; B32B 2605/00

(57) ABSTRACT

A sunroof that can be illuminated by a light source, includes a first glass sheet and a second glass sheet, between which a lamination interlayer and a holographic layer including a thick reflection hologram are placed, the hologram being suitable for diffracting, towards the outside of the sunroof, via the second glass sheet, at least some ray s guided in the sunroof.

The present invention relates to illuminable vehicle roofs.

It is known practice to incorporate inorganic light-emitting diodes, also referred to as LEDs, into the edge of single-or laminated glazing units so that the light emitted by the diodes enters via the edge face of a sheet of glass and is guided thereby as far as a diffusing element, also referred to as a light extraction means.

In particular, there are illuminating glazings, cited for example in patent application FR3034501A1 whose diffusing element (or extraction means) is a diffusing layer comprising diffusing dielectric particles in a matrix.

There is a need for producing an illuminating glazing from which the light is extracted with good extraction efficiency and discreetly in the off-state.

To this end, one aspect of the invention relates to a laminated vehicle sunroof comprising:
a first sheet of transparent mineral glass, known as the outer sheet, having a first main face, known as face F1, and an opposite second main face, known as face F2, with a refractive index nᵥ at a first wavelength λ1 in the visible range preferably greater than or equal to 1.5
a second, inner, glass sheet made of transparent organic or mineral glass, with a refractive index n₀ at λ1, having a main face known as face F3 and an opposite main face known as face F4,
between face F2 and face F3, a dielectric lamination interlayer of polymer material, comprising at least one lamination interlayer,
the sunroof comprising, between face F2 and F3, in this order moving away from F2: preferably one or more upper transparent dielectric intermediate layers with given refractive indices in the visible range, in particular the upper intermediate layer(s) are interlayer(s),
the first sheet being tinted and/or a first layer of the upper intermediate layer(s) being tinted, in particular a first tinted interlayer,
when several upper intermediate layers are tinted, the first tinted layer is the tinted layer closest to face F3,
a first transparent dielectric holographic layer comprising a first functional zone with a first thick hologram, diffracting at λ1, the first functional zone having a refractive index n_{H1} at λ1
preferably, between the first functional zone and face F3, one or more lower transparent dielectric intermediate layers, notably interlayers,
n₂ being the lowest refractive index at λ1 in the visible range:
a) from the refractive indices of the upper intermediate layer(s), notably interlayer(s), between the first holographic layer, excluded, and up to and including the first tinted layer
b) or in the absence of a tinted upper intermediate layer or in the absence of an upper intermediate layer n₂ being equal to nᵥ
n₁ being the lowest refractive index at λ1 from the refractive indices of any lower intermediate layer(s), of the first functional zone and n₀, with n₂<n₁ the roof being adapted to receive a light beam in the second glass sheet, light rays injected at λ1 into the second glass sheet, with a range θ1 of angles of incidence in the second glass sheet, being guided in the roof until reaching the first hologram and with θ1 such that arcsin (n₂/n₀)≤θ1≤arcsin (n₁/n₀) the optical function of said first hologram being selected such that a portion of the rays guided in the roof (in range θ1) reach the first hologram and are diffracted and extracted from the roof on the side of face F4, the diffracted rays defined by a range of angles of incidence θ2 on face F4 (in the second glass sheet), and lying between −arcsin (1/n₀) and arcsin (1/n₀).

In particular, the range θ1 represents the angles of incidence with respect to the vector locally normal to the lower face of the layer at the point of impact of the guided rays.

The invention advantageously enables light waves to be extracted in a particular range of angles by virtue of a hologram. In particular, the use of a thick hologram is particularly advantageous as these holograms benefit from high diffraction efficiency, which means high luminance. Additionally, holograms have a wavelength and angular selectivity that increases with their thickness, which means that they can be highly transparent. These two properties make holograms particularly interesting features for the illumination of the sunroof, as most state-of-the-art solutions based on light diffusion suffer from a compromise between blurred vision through the glazing and efficient extraction of light rays. Extraction efficiency is defined as the total light diffracted by the hologram over the entire surface so as to emerge from the glass (within the specified angle range) relative to the light injected into the guide.

Additionally, the intrinsic efficiency of the hologram is defined, i.e. the fraction of incident light on the hologram that is redirected thereby, can be selected from at least one threshold value based on the size of the system (hologram and guide). The larger the system size, the lower the threshold value, to ensure even illumination. For example, an intrinsic efficiency of 30% is well suited to an interaction length with the hologram, typically the length of the hologram, of one meter.

In particular, the laminated hologram is designed so as to diffract the guided light out of the roof. For example, one or more light sources (diodes, etc.), notably placed on the edge of the second glass sheet (for direct injection) or else on the side of face F4 and coupled to a light redirection element on side of face F3 or F4 so that the light propagates in the second glass sheet, can advantageously read the hologram in order to provide an illuminated (or not) sunroof, potentially with a graphic design for decorative applications. In this fashion, it is possible to obtain an interesting compromise between transparency and extraction efficiency.

The invention takes advantage of the thickness of the tinted material (first tinted sheet or any first tinted layer). In fact, while the most grazing rays are guided in the second sheet by total internal reflection at the interface with the intermediate layer (lower intermediate interlayer, for example), other, less grazing rays, propagating through the glazing by refraction, reach the tinted material and are rapidly absorbed after a few bounces following their refraction and their reflection.

The tinted thickness thus creates an angular filter that eliminates the need to deal with less grazing angles. Thus, the tinted material has two advantages. The first advantage is that it requires large guided angles. By registering the hologram to operate in this angular range, the angles coming from outside are very far from the Bragg condition, and therefore not optimal for diffraction. The second advantage is that, by attenuating the light coming from outside, there is necessarily less stray light likely to interact with the hologram. Thus, the two advantages are firstly greater brilliance with less haze than a diffuser and secondly fewer optical defects than just a hologram between two glasses.

In particular, the first glass sheet and/or any tinted intermediate layer (PVB, EVA or polyester film interlayer, including PET, etc.) are sufficiently absorbent, taking into account their absorption coefficients and thicknesses, so that in the case of bounce back, i.e. their refraction from face F3 to face F1, then their reflection on face F1, and finally their refraction up to face F3, the light intensity is reduced by at least 50%.

Light intensity can be measured by transmission spectroscopy. Typically, the extinction coefficient k, the imaginary part of the complex refractive index for a 2 mm VG 10 glass from the Applicant (or for a 0.76 mm tinted PVB with 40% LT) is of the order of 10⁻⁸ in the visible range (in particular at the reference wavelength and even over the spectral range of the source).

It is preferable for any first tinted layer or the first sheet of tinted glass to be over-tinted and therefore sufficiently absorbent. It is preferable for the first tinted layer to be passive rather than a variable-tint layer of an electrically controllable device. However, functionalities such as a variable-tint or variable-haze layer can be added preferably between face F2 and a tinted layer (preferably the first tinted layer).

A tinted intermediate layer (interlayer, upper and/or lower intermediate layer) according to the invention can have a light transmission of at most 50%, or at most 40%, or at most 30%, or at most 20%.

For the first tinted layer, it is possible to select a different or identical color of tint to that of the first glass sheet if also tinted. For example the first sheet of tinted glass is green, blue or gray and the first tinted layer, preferably an interlayer (for example made of PVB material), is blue or gray. At least one other intermediate layer, preferably a clear interlayer, for example clear PVB, can be added closer to face F2 than the first tinted layer or closer to face F3.

At least one lower intermediate layer may be a (lower) adhesive layer (separate and) in contact with the first holographic layer and even with face F3 and/or an upper intermediate layer may be an (upper) adhesive layer in contact with the first holographic layer and even with face F2, a local (upper and/or lower) adhesive layer (extending slightly or not beyond the first holographic layer, for example less than 1 cm beyond) or so-called extended layer extending over at least 80%, or even at least 90%, 95% of the main face of the roof to form an (upper and/or lower) lamination interlayer. There may be local lower and upper adhesive layers or a local lower adhesive layer and an extended upper adhesive layer or else an extended lower adhesive layer and a local upper adhesive layer, or extended lower and upper adhesive layers.

The first holographic layer may be a coating preferably on face F3 or even on face F2, or a (self-supporting) film. The first holographic layer may be:
in contact with an upper adhesive layer (extended or local) which is for example a film with a low refractive index, attached or bonded to face F2
and/or in contact with a lower intermediate layer (extended, in particular a PVB-based layer, or local) attached or bonded to face F3.

In addition to the features just mentioned in the preceding paragraph, the sunroof according to one aspect of the invention can have one or more additional features from the following, considered individually or according to all of the technically possible combinations thereof:
the first hologram is reflective,
n₀ is between 1.5 and 1.62 at λ1,
n₂ is less than or equal to 1.48 at λ1 or even to 1.45 and preferably at least 1.3
nᵥ is between 1.5 and 1.55 at λ1,
n₂ is less than or equal to 1.45 with nᵥ greater than n₂ (and preferably with an upper intermediate layer which is an adhesive layer, notably local or extended, in particular a layer of crosslinked material),
n₁ is greater than or equal to 1.48 and notably n₁ is greater than no and preferably a lower intermediate layer is an adhesive layer (local or extended, in particular a PVB-based layer),
n₁ is less than or equal to n_{H1} and even n₁ -n_{H1} is at most 0.2 or 0.1, (so that the first hologram receives as much light as possible),
the first hologram is a preferably sinusoidal diffraction grating,
the first hologram is a set of off-axis Fresnel zones, notably obtained from a microlens array, and in particular obtained from recording the field transmitted by a matrix of microlenses.

The sunroof may comprise a light source (notably diodes) optically coupled to the second sheet (by the edge face via an inner wall delimiting a hole in the second sheet, or on the side of face F4 and associated with a light redirection element notably prismatic on the side of face F4 or on the side of face F3, in particular a monochromatic light source at said first wavelength λ1 and a full width at half maximum of preferably at most 30 nm, λ1 is preferably selected in a first range LB1 from 450 nm up to 510 nm excluded or in a second range LB2 from 510 nm up to 560 nm excluded, or in a third range LB3 from 560 nm up to 650 nm, or better still from 620 nm up to 650 nm (in particular λ1=532 nm±30 nm, which corresponds to green, λ2=480 nm±30 nm, which corresponds to blue, or even λ3=680 nm±30 nm, which corresponds to red). An upper intermediate layer can be an interlayer with index nᵢ equal to 1.48 in the visible range, and λ1 is in the first range LB2 or LB1, preferably LB2.

The sunroof may comprise a polychromatic light source (comprising one or more light sources, notably diodes), optically coupled to the second sheet, the polychromatic light source emitting:
at said first wavelength λ1 selected from within a first range which is in a first range LB1 from 450 nm up to 510 nm excluded or in a second range LB2 rom 510 nm up to 560 nm excluded, or in a third range LB3 from 560 nm up to 650 nm, or better still from 620 nm to 650 nm, (the light source having notably a first source with a full width at half maximum of preferably 30 nm centered on λ1)
at a second main wavelength λ2 separate from λ1 and selected in a second range separate from the first range and which is in the first, second or third ranges LB1, LB2, LB3, (the light source having notably a second light source with a full width at half maximum of preferably 30 nm centered on λ2) and preferably at a third main wavelength λ3 separate from λ1 and λ2 and selected in a third range separate from the first range and the second range which is in the first, second or third ranges LB1, LB2, LB3, (the light source having notably a third light source having a full width at half maximum of preferably 30 nm centered on λ3), preferably the first range is in LB2, the second range is in LB1, the third range is in LB3.

The first so-called multi-band hologram (for example multiplexed) also diffracts at the second wavelength λ2, the first functional zone having a refractive index N_{H2} at λ2 or even also diffracts at the third wavelength λ3, the first functional zone having a refractive index n_{H3} at λ3 or the roof comprises a second hologram diffracting at 12 between the first hologram and face F3, with a second holographic layer having a second functional zone having a refractive index n_{H2} at λ2 and optionally the roof comprises a third hologram diffracting at λ3, between the second hologram and face F3, with a third holographic layer with a third functional zone having a refractive index n_{H3} at λ3, n₂ₐ being the lowest refractive index at 2 in the visible range:
a) in the case of a second functional zone, from the refractive indices at λ2 of the lower intermediate layer(s) above (moving towards face F2) the second functional zone, the first functional zone, the upper intermediate layer(s) and up to and including the first tinted layer,
b) or in the case of a first multi-band hologram, from the refractive indices of the upper intermediate layer(s) (notably the interlayer) between the first holographic layer excluded and up to and including the first tinted layer
c) or in the absence of a tinted upper intermediate layer or upper intermediate layer, n₂ₐ being equal to nᵥₐ, where nᵥₐ is the refractive index at λ2 in the visible range of the first sheet and
i) n₁ₐ being the lowest refractive index at λ2 from the refractive indices of any lower intermediate layer(s) below the second functional zone (towards face F3), the index n_{H2} of the second functional zone, and n₀ₐ which is the refractive index at λ2 in the visible range of the second sheet
j) or in the case of a first multi-band hologram, n₁ₐ being the lowest refractive index at λ2 of the refractive indices of any lower intermediate layer(s) (below the first functional zone), the index n_{H2} of the first functional zone, and n₀ₐ which is the refractive index at λ2 in the visible range of the second sheet the optical function of said second hologram or of the first multi-band hologram being selected such that a portion of light rays injected at λ2 into the second glass sheet, guided in the roof, (in range θ1), reaches the second hologram or the first multi-band hologram and is diffracted and extracted from the roof on the side of face F4 in all or part of the range of angles of incidence θ2 on face F4 (in the second glass sheet), and lying between −arcsin (1/n₀ₐ) and arcsin (1/n₀ₐ),
and optionally, n_{2b} being the lowest refractive index at λ3 in the visible range:
a′) in the case of a third functional zone, from the refractive indices at λ3 of the lower intermediate layer(s) above (towards face F2) the third functional zone (including the second functional zone), the first functional zone, the upper intermediate layer(s) and up to and including the first tinted layer,
b′) or in the case of a first multi-band hologram, from the refractive indices of the upper intermediate layer(s) (notably the interlayer) between the first holographic layer excluded and up to and including the first tinted layer
c′) or in the absence of a tinted upper intermediate layer or upper intermediate layer, n_{2b} being equal to n_{vb} where n_{vb} is the refractive index at λ3 in the visible range of the first sheet and
n_{1b} being the lowest refractive index at λ3 from the refractive indices of any lower intermediate layer(s) below the third functional zone (towards face F3), the index n_{H3} of the third functional zone, and nob which is the refractive index at λ3 in the visible range of the second sheet
the optical function of said third hologram or first multi-band hologram being selected such that a portion of light rays injected at λ3 into the second glass sheet, guided in the roof, (in range θ1), reaches the third hologram or the first multi-band hologram and is diffracted and extracted from the roof on the side of face F4 in all or part of the range of angles of incidence θ2 on face F4 (in the second glass sheet), and lying between −arcsin (1/n_{0b}) and arcsin (1/n_{0b}) for a given direction of observation in range θ2:
the first hologram diffracting at λ1 having a maximum diffraction efficiency in a first sub-range of θ1a with a width of at least 1°
the second hologram or the first multi-band hologram diffracting at λ2 having a maximum diffraction efficiency in a second sub-range of θ1b with a width of at least 1° with partial or disjoint overlap of θ1a
the optional third hologram or the first multi-band hologram, diffracting at λ3, having a maximum diffraction efficiency in a third sub-range of θ1c with a width of at least 1° with partial or disjoint overlap with first and second sub-ranges θ1a and θ2a (the total of θ1a, θ1b, θ1c is preferably at least 60%, 80% of θ1). n_{H1} and n_{H2} are not necessarily separate, as the medium may or may not be dispersive. For example, it is possible to have two or three index modulations around a single index n_{H}. In particular, n_{H3} is separate from n_{H1} and n_{H2}.

The first multi-band hologram is for example a multiplexed hologram, a linear combination of optical functions (herein in particular two optical functions or three optical functions).

Alternatively, the roof comprises a stack of a first and a second hologram, notably a lower intermediate layer forming the second holographic layer comprising said second functional zone in optical contact via local adhesive or lamination interlayer, with the first functional zone.

There is a stack of first, second and third holograms and in particular with a second functional zone, a lower intermediate layer forming the second holographic layer comprising said second functional zone in optical contact via local adhesive or interlayer, with the first functional zone, and with a separate third functional zone, another lower intermediate layer forming the third holographic layer comprising said third functional zone in optical contact, via local adhesive or lamination interlayer, with the second functional zone. In one embodiment, the second hologram can be multi-band with two optical functions for λ2 and λ3.

The sunroof may comprise:
a first upper intermediate layer, the interlayer, of crosslinked adhesive material, with a refractive index equal to n₂ preferably at most 1.45 at λ1
a first lower intermediate layer, the interlayer, with a refractive index of at least 1.48 at λ1, notably made of thermoplastic material, in particular PVB or EVA (thermoplastic or crosslinked)
a second mineral glass sheet.

The holographic layer is a photopolymer, the first functional zone has an index modulation dn around a refractive index n_{H0} at an inscription wavelength in the visible range AO which is preferentially in the spectral band of a monochromatic or polychromatic light source optically coupled to the second sheet. Advantageously, this preferential feature avoids the need for pre-compensation which would require a change of reference angle in anticipation of the wavelength difference. In particular, the holographic layer comprises a multi-band hologram diffracting at λ1, λ2, λ3 or the roof comprises second and third holograms respectively diffracting at λ2, λ3 and λ0 is in a spectral band (in particular LB2) including the value of the medium from λ1, λ2, λ3, and even the second and third holograms have separate inscription wavelengths in the visible range λ′0 and λ″0, separate from AO in a spectral band including a separate value of the medium from λ1, λ2, λ3 (in particular LB1 and LB3). In particular, the index modulation is small around n_{H1}, n_{H1} being dependent on the wavelength to which the material is exposed.

The number of upper intermediate layers is denoted N. N is, for example, at most 4 or 3 or 2 or 1, preferably at least 1 or even 0 if the first holographic layer is capable of bonding the sheets (sufficient adhesion with the sheets). The upper intermediate layers can have various possible functionalities—an adhesive layer, notably a lamination interlayer, a tinted layer, a functional layer support (electrically conductive, heating, low-emissivity, athermal, etc.). Each upper intermediate layer can have a sub-millimeter thickness and is for example a film at least 30 μm or 50 μm thick.

An upper or lower intermediate layer may comprise a thermoplastic polymeric sheet that is notably adhesive to the glass sheets. The polymers are selected from polyvinyl butyral (PVB), polyurethanes (PU), polyureas, ethylene vinyl acetate (EVA), polyolefins (including polyethylene (PE), polypropylene (PP) or polyisobutylene (P-IB)), polyvinyl chloride and its derivatives (for example, polyvinyl dichloride (PVDC)), styrenic polymers (for example, polystyrene (PS), acrylostyrene butadiene (ABS), styrene acrylonitrile (SAN)), polyacrylics (including polyacrylonitrile (PAN) and poly(methyl methacrylate) (PMMA)), polyesters (including poly(ethylene terephthalate) (PET) and poly (butylene terephthalate) (PBT)), polyoxymethylene (POM), polyamides (PA), fluoropolymers such as polychlorotrifluoroethylene (PCTFE), polycarbonates (PC), aromatic polysulfones including polysulfone (PSU), polyphenylene ethers (PPE), epoxies (EP) alone or in blends and/or copolymers of several of these.

A lamination interlayer, lower or upper intermediate layer, can be a sheet based on PVB or PU (flexible) or plasticizer-free thermoplastic (ethylene copolymer/vinyl acetate (EVA), etc.), with each sheet being for example between 0.2 mm and 1.1 mm thick, notably 0.38 and 0.76 mm. Preferably, any PVB-based interlayer, in sheet form, comprises from 70% to 75% PVB, 25 to 30% plasticizer and less than 1% additives. There are also PVB sheets with little or no plasticizer such as the “MOWITAL LP BF” film from KURARAY. Thus, the lamination interlayer can be or can comprise a sheet based on (made of) poly(vinyl butyral) (PVB) containing less than 15% by weight of plasticizers, preferably less than 10% and better still less than 5% by weight, and in particular without plasticizer, and particularly at most 0.15 mm thick, in particular from 25 to 100 λm, 40 to 70 λm, and even 50 λm, for example the product called Kuraray Mowital®.

The lamination interlayer can be acoustic, in particular it can comprise or consist of an acoustic PVB (three-layer, four-layer, etc.). Thus, the lamination interlayer can comprise at least one layer, called central layer, made of viscoelastic plastic with vibro-acoustic damping properties, particularly based on polyvinyl butyral and plasticizer, and the interlayer, and further comprising two external layers made of standard PVB, with the central layer being between the two external layers. Mention may be made of the acoustic PVBs described in patent applications WO2012/025685, WO2013/175101, especially tinted as in WO2015079159.

The upper intermediate layers have various possible functionalities: adhesive layer, lamination interlayer, or other. Each upper intermediate layer has a sub-millimeter thickness and is for example a film at least 30 μm or 50 μm thick.

The lamination interlayer can be single-layer, and can preferably be the first upper intermediate layer or a tinted film. The lamination interlayer is preferably multi-layer, and comprise notably two, three or four adhesive layers, notably adhesive films or sheets. In particular, the lamination interlayer can comprise a clear upper intermediate layer (notably with no added dyes) and a clear lower intermediate layer. The lamination interlayer may notably comprise a clear or tinted upper intermediate layer and a clear lower intermediate layer in adhesive contact with the holographic layer. The layers forming the lamination interlayer can be made of different materials, in particular at least one thermoplastic layer and another layer is a crosslinked adhesive. For example, the lower intermediate layer is a thermoplastic layer, made of PVB or EVA (thermoplastic) for example, and for a first upper intermediate layer (with low index), a crosslinked adhesive layer and optionally a second thermoplastic (PVB) upper intermediate layer, notably tinted (PVB or EVA). EVA can be a thermosetting sheet.

In particular, for the lamination interlayer, at least a first upper intermediate interlayer and preferably at most two or at most three upper interlayers and a single lower intermediate layer which is an interlayer layer are provided.

If the tinted layer is an interlayer made for example of PVB or EVA thermoplastic, at most a single first upper intermediate layer is preferred which is preferably an interlayer made, for example, of crosslinked adhesive.

Films, for example self-supporting films, are preferred as interlayers.

The interfaces between interlayers, the sheets for example, are not necessarily discernible. The interlayer can incorporate elements, non-adhesive to the glass, such as functional polymer films or electro-optical elements, sensors, of various extents, on all or part of the glazing. For example, a polymer film such as PET is sandwiched between two thermoplastic sheets (PVB etc.).

It is also preferable for a lamination interlayer to be selected with as little haze as possible, i.e. with a haze of at most 1.5% and even of at most 1%.

The first holographic layer, notably film, may be in several spaced-apart or abutting parts. The first holographic layer can occupy a portion of the surface spaced from the light beam propagation zone. The far edge can stop short of the extinction zone for guided rays (absorption during propagation), typically 50 cm for extra-clear glass. The width of the holographic layer is preferably at least centimetric and for example at least 10 cm.

Preferably, between the first functional zone and face F3, the sunroof comprises one or more lower, transparent, dielectric intermediate layers. Said lower intermediate layers are notably interlayers. The number of lower intermediate layers is denoted M. Preferably, M is for example at most 2 or 1, or even 0. Each lower intermediate layer can have various possible functionalities but is preferably adhesive and is clear rather than tinted. Each lower intermediate layer preferably has a sub-millimeter thickness, and is for example a film, being preferably at least 30 μm or 50 μm thick.

There may be one or more lower and/or upper functional chemical barrier layers, for example one or more diffusion barrier layers, for example between the holographic layer and the lower intermediate interlayer. In this case, the first upper intermediate layer can be this protective layer or be a lower intermediate layer between the holographic layer and another lower intermediate layer such as PVB

It is desirable to avoid overly reflective, diffusive or absorbent coatings for the upper and lower intermediate layers.

The single-layer or multi-layer lamination interlayer is notably at most 1.2 cm or subcentimetric thick, and is in particular greater than 0.3 mm thick, notably all or part thermoplastic (tinted or not), with for example at least one lower part of the interlayer (tinted or not) known as the lower intermediate interlayer (for example a sheet) of a given thickness of preferably at least 100 μm thick, in adhesive contact with face F3.

The sunroof is thus tinted, therefore absorbent in the visible range in particular in the spectral range of the light source, over a given thickness whose value is for example at least 100 μm or at least 300 μm. In particular:
the first glass sheet is tinted, over its entire thickness by being bulk colored,
and/or on all or part of the lamination interlayer, preferably the tinted thickness is submillimetric, for example an upper intermediate interlayer, between face F2 and the lower intermediate interlayer, is tinted, bulk colored, and/or the lower interlayer is tinted,
and/or a tinted transparent, bulk colored, polymeric film, in particular non-adhesive to mineral and/or organic glass, for example with a thickness of at least 30 μm or at least 50 μm and at most 200 μm. The tinted transparent film is inserted between face F2 and the lower intermediate interlayer, for example within the lamination interlayer, between the lower intermediate interlayer and an upper intermediate interlayer.

For example, the tinted transparent film is a thermoplastic film, preferably flexible and curved to match the curvature of the glazing. The tinted transparent film is for example: polyester, notably polyethylene terephthalate (PET), polybutylene terephthalate PBT, poly(ethylene naphthalate) (PEN), polyimide (PI), polyurethane (PU) or cellulose triacetate (TAC), acrylic, polyolefin, notably polypropylene (PP), polycarbonate (PC) or PMMA, (coextruded) film made of PET-PMMA poly(vinyl chloride) PVC. With a polymer film made of PC or PMMA, thermoplastic polyurethane (TPU) is preferred, for more chemical compatibility, as a thermoplastic interlayer. Similarly, if a second sheet of organic PC or PMMA glass is selected, preferred are a thermoplastic interlayer, notably a lower intermediate layer, for example thermoplastic polyurethane (TPU).

A fluoropolymer film, which is a thermoplastic, can be selected to bond to face F2 as an upper intermediate layer with a low refractive index, which is not an interlayer, for example between two interlayers formed from PVB or EVA. The fluoropolymer film may be based on or even made from one of the following materials: perfluoroalkoxy PFA, notably with a refractive index of about 1.3, poly(vinylidene fluoride) PVDF, notably with a refractive index of about 1.4, ethylene chlorotrifluoroethylene ECTFE, ethylene tetrafluoroethylene ETFE, more precisely poly(ethylene-co-tetrafluoroethylene, notably with a refractive index of about 1.4, fluorinated ethylene propylene copolymer FEP notably with a refractive index of about 1.3 or polytetrafluoroethylene PTFE notably with a refractive index of about 1.3, polyvinyl fluoride (PVF).

A preferably upper or lower intermediate layer according to the invention can be made of a crosslinked polymer material notably an optical adhesive (OCA for optically clear adhesive, LOCA if liquid).

The advantage of this adhesive layer is that the refractive index can be selected as required and in particular for low-index layers without sacrificing transparency. It is therefore particularly sought-after as an upper, local intermediate layer or forming an interlayer having the refractive index n₂.

For the manufacture of this layer (intermediate), crosslinkable adhesives which cure when their components react (photo-crosslinkable notably under ultraviolet, thermo-crosslinkable, etc.) or when a solvent evaporates can be used. In all cases, there is a chemical reaction in order to create chemical bonds for the cross-linking, in which case the crosslinked polymer is defined by the formation of a 3D network of polymer chains bound by chemical bonds.

Thus, the way in which the cross-linkable adhesive cures depends on its nature, with some adhesives (photo)cross-linking notably by the application of ultraviolet (UVA) or visible (400-405 nm) energy. Others crosslink at room temperature with the addition of a hardener by chemical reaction. Other crosslinkable adhesives are crosslinked by chemical reaction initiated and favored by virtue of the supply of thermal energy.

Liquid deposition of the crosslinkable adhesive can be done by spray coating, curtain coating, flow coating, roller coating, slot die, dip coating or casting, blade coating, screen printing, inkjet, drop casting, or by filling a cavity with a syringe in particular.

Preferably, the crosslinked adhesive layer can be photo-crosslinked by ultraviolet irradiation. The adhesive layer may for example comprise an ultraviolet photo-crosslinked polymer matrix.

According to one embodiment, the crosslinked adhesive layer is in particular an adhesive film preferably at least 30 μm thick, and is preferably a pressure-sensitive film, preferably selected from acrylate, urethane acrylate or fluoro urethane acrylate or silicone-based polymers or is an adhesive coating preferably at least 1 μm thick.

According to another embodiment, the crosslinked adhesive layer is a crosslinked polymer-based adhesive film, notably of at least 30 μm, selected from a pressure-sensitive film, preferably selected from acrylate, urethane acrylate or fluoro urethane acrylate or silicone-based polymers and a so-called post-adhesive film of partially crosslinked polymer prior to assembly, preferably photo-crosslinked and acrylate-based.

In particular for a low refractive index (for n₂ in particular), the crosslinked polymeric material of the adhesive crosslinked layer is for example selected from polymers based on polyacrylate, in particular urethane acrylate or fluoro urethane acrylate or fluoro silicone acrylate, polysiloxanes, silicone, notably poly dimethylsiloxane, epoxy polymer or polyepoxides, polyurethane, polyvinyl acetate, polyester.

In particular the crosslinked polymer material of the adhesive crosslinked layer is preferably selected from an acrylate-based polymer, notably urethane acrylate or silicone acrylate or silicone-based, and the polymer further having a fluorinated function.

It is possible to cite the following examples of a crosslinkable liquid (UV) adhesive for liquid deposition:
adhesive based on urethane acrylate for example from Norland, notably the product called LOCA Norland NOA 1315, with a refractive index of 1.315, which is an aliphatic urethane acrylate,
adhesive based on fluoro urethane acrylate for example from Shin-A, notably the product called SFA 335, with an index n₁ between 1.335 and 1.339 or SFA 387 with a refractive index between 1.385 and 1.389,
adhesive based on acrylate for example notably the product called UZ181A (refractive index 1.47) from AKChemTeck, or else the product called UVEKOL S15, with a refractive index of 1.44, from Allnex.

Mention may be made of liquid adhesives based on fluorourethane acrylate, for example from Shin-A, notably the product called LOCA Shin-A 335, with a refractive index between 1.335 and 1.339 or 387, with a refractive index between 1.385 and 1.389.

Pressure-sensitive adhesives (PSA) are sold in the form of double-sided adhesive rolls with a liner on each face to protect the PSA film.

Silicone-based PSAs include adhesives from Dow Corning®, Taica such as OPT alpha GEL® such as K120E, K90E or MRK adhesives such as MR3050, MR3080. Acrylate-based PSAs include adhesives from Nitto such as CS98210U, CS98210UK or Tesa® adhesives such as OCA 69206, OCA 69208, OCA 69405.

The edge face or outer edge of the layers may be offset from the clear glass area, notably extending under an inner peripheral masking layer between face F2 and face F3.

Additionally, face F4 may comprise an infrared radiation-reflective coating (low emissivity) with one or more electrically conductive functional layers.

Preferably, the coating of face F4 is free of silver and/or gold layers. The electrically conductive functional layer can be based on oxide and/or based on metal nitride. The electrically conductive functional layer can be based in particular on a transparent conductive oxide or TCO layer (for transparent electrically conductive oxide) selected in particular from: fluorine-doped tin oxide, antimony-doped tin oxide and/or indium tin oxide, zinc oxide doped or undoped with aluminum, gallium or antimony. The TCO electrically conductive functional layer is preferably a layer of fluorine-doped tin oxide (SnO2: F) or a layer of mixed indium tin oxide (ITO). In particular, the coating comprises a single TCO layer and even ITO. Other electrically conductive functional layers TCO are possible, including thin layers based on mixed indium-zinc oxides (referred to as “IZOs”), based on gallium-doped or aluminum-doped zinc oxide, based on niobium-doped titanium oxide, based on cadmium or zinc stannate, or based on antimony-doped tin oxide.

The infrared reflective coating is preferably multi-layered, notably deposited by magnetron sputtering, and comprises a first dielectric underlayer or even a second dielectric underlayer, in particular:
metal oxide-or silicon-based: zinc-tin oxide, zinc oxide or titanium oxide- or silica-based layers
based on metal or silicon nitride or oxynitride, notably based on nitride of one or more elements selected from silicon, aluminum or zirconium, preferably based on silicon nitride,
or silicon carbide or oxycarbide.

The glazing according to the invention may comprise an electrically controllable device between face F2 and face F3, with a stack formed from the following elements: dielectric support (PET film for example), electrode (transparent ITO for example), active layer, electrode, dielectric support and notably an electrically controllable device between two sheets of the lamination interlayer, which is formed from PVB, for example.

The electrically controllable device can be selected from a variable haze device and a variable tint device.

A variable haze device is a liquid crystal device with a stack formed of the dielectric support, electrode, active layer, electrode, dielectric support and notably an electrically controllable device between two sheets of the lamination interlayer formed for example of PVB etc. A variable-tint device is an electrochromic device for example.

The electrically controllable device is for example, all or part opposite or offset from the guided light extraction means, the extraction means being the first hologram, and/or the second hologram, and/or the third hologram. Additionally, the electrically controllable device is preferably between face F2 and the first tinted layer, the first tinted layer being for example the upper intermediate tinted interlayer for example.

Between face F3 and the first tinted layer, it is preferable to avoid any layer, of at least 10 nm, which is for example an electrode and, any layer formed of pure or nitrided metal for example, or else a transparent conductive oxide or even any layer with an extinction coefficient k, k being the imaginary part of the complex refractive index of said layer, of at least 10⁻⁴ or even at least 10⁻² in the visible range, in particular at the reference wavelength for example 550 nm and even over the spectral range of the source.

The sunroof according to the invention may also comprise a layer that reflects or absorbs infrared (solar control), on face F2 or on a polymer film, in particular a stack of thin layers referred to as low-emissivity thin layers comprising at least one metal layer such as silver, the or each silver layer being arranged between dielectric layers. In this configuration, the first tinted layer (preferably an interlayer) is closer to face F3 than this low-emissivity stack and the first glass sheet is clear and even any layer, the interlayer for example, between face F3 and the low-emissivity stack.

More generally, between the first tinted layer and face F3, it is preferable to avoid any layer, of at least 10 nm, formed of pure or nitrided metal for example, or else transparent conductive oxide, having an extinction coefficient k, k being the imaginary part of the complex refractive index, of at least 10⁻⁴ or even of at least 10⁻² in the visible range, in particular at the reference wavelength for example 550 nm and even over the spectral range of the source.

Preferably, the lower and/or upper intermediate layer(s), up to the first tinted layer, have an extinction coefficient k, imaginary part of the complex refractive index, of at most 10⁻⁵ or even 10⁻⁷ in the visible range, in particular at the reference wavelength for example 550 nm and even over the spectral range of the source.

The lamination interlayer may have an upper or tinted layer, having a main face FA in adhesive contact with the bare face F2 or with a functional coating on face F2. The laminated glazing can in fact comprise a solar radiation-reflecting or absorbing layer on face F2, in particular a stack of thin layers comprising at least one silver layer, where each silver layer is arranged between dielectric layers.

The lamination interlayer can have a lower intermediate layer with a main face FB in adhesive contact with the bare face F3 and with the holographic layer. In a zone close to the injection, the glazing can be masked, with a trim, and/or with a peripheral masking layer.

In one embodiment, the glazing comprises an internal, peripheral, opaque masking layer between face F3 and face F2, notably an internal masking layer in contact with face F2, notably defining the clear glass area. And/or the glazing may comprise an internal opaque peripheral masking layer on face F4, notably congruent with or narrower than the width of the internal masking layer.

The internal opaque peripheral masking layer is notably an enamel, black for example, on face F2. This can be an opaque coating on a thermoplastic adhesive layer, notably upper intermediate interlayer, in particular PVB, for example an opaque PVB-based coating and with dye on one main face of a PVB layer face oriented toward face F2 or F3.

The internal masking layer may be 2 mm or 3 mm and preferably less than 5 mm, from the edge face of the sunroof or even go up to the edge face. The internal masking layer may be a band framing the sunroof and notably a black band. Opacifying is carried out over the entire periphery of the sunroof to conceal bodywork elements or seals or to protect an adhesive for mounting on the vehicle. The internal masking layer can delimit the clear glass area. It may be advantageous for the external edge of the optical insulating layer to be masked by the internal masking layer, not in the clear glass area.

The width of the internal masking layer along the sides of a motor vehicle roof is generally less than that at the front or even at the rear.

For example, for the sunroof, the width of the internal, and even interior, masking layer, along the longitudinal edges of the sunroof can be at most 30 cm and notably 10 cm to 20 cm.

For example, for the sunroof, the width of the internal, and even interior, masking layer, along the rear lateral edge can be at most 30 cm and notably at least 1 cm or 5 cm and along the front lateral edge at most 60 cm notably at least 1 or 5 cm.

Preferably, the width of the internal masking layer is greater than that of the interior masking layer.

The interior peripheral masking layer can be on face F4, notably facing the internal masking layer, and even of identical nature for example an enamel notably black on the second mineral glass sheet. The interior masking layer may be 2 mm or 3 mm (less than 5 mm) from the edge face of the glazing or even up to the edge face.

The interior masking layer, notably black, can be a band and even a frame. The interior masking layer can be adjacent to an infrared reflective coating, in contact or spaced apart.

The internal and/or interior masking layer may be an organic or mineral binder, for example sintered glass frit, with an organic or inorganic dye notably molecular dye or inorganic pigment.

The internal and/or interior masking layer is preferably a continuous layer (flattened with a solid edge or alternatively a gradient edge (set of patterns)). The thickness of each intermediate layer between face F2 and face F3 is preferably at most 1.5 mm or 1.1 mm or 0.9 mm and in particular the thickness of each lamination interlayer is at most 1.1 mm or 0.9 mm. The thickness between face F1 and face F4 is preferably at most 9 mm or 7 mm, notably for a road vehicle.

The first glass sheet is preferably made of mineral glass optionally tempered notably if it is intended to be the exterior sheet and if the second sheet is made of organic glass. In particular for a vehicle sunroof, the first (exterior) glass sheet is preferably at most 2.5 mm thick, even at most 2.2 mm thick-notably 1.9 mm, 1.8 mm, 1.6 mm and 1.4 mm-and even at least 0.7 mm thick.

The second glass sheet can have a thickness of at least 0.7 mm, optionally less than that of the first exterior glass sheet, even at most 2.2 mm-notably 1.9 mm, 1.8 mm, 1.6 mm and 1.4 mm-or even at most 1.3 mm or at most 1 mm.

The total thickness of the first and second sheets of glass is preferably strictly less than 5 or 4 mm, even 3.7 mm.

The first and second glass sheets can notably be substantially identical in size, for example generally rectangular in shape. The first glass sheet, if exterior, may be larger than the second sheet, if interior, thus protruding beyond this second sheet over at least part of its periphery, optionally second sheet, on the passenger compartment side, that is smaller with an edge face that is recessed notably by at most 10 or 5 cm from the edge face of the first glass sheet, on one edge or several, longitudinal and/or lateral edges, notably or over the entire periphery.

The first sheet may be a clear glass with a functional athermal or even heating coating on face F2.

The first mineral glass sheet may be based on silica, soda-lime, preferably soda-lime-silica, or even aluminosilicate or borosilicate. It may have a total iron oxide content by weight (expressed in the form Fe2O3) of at least 0.4% and preferably of at most 1.5%.

The second mineral glass sheet may be based on silica, soda-lime, soda-lime-silica, aluminosilicate or borosilicate. To limit the absorption has a total iron oxide content by weight (expressed in the form Fe2O3) of at most 0.05% (500 ppm), preferably at most 0.03% (300 ppm) and of at most 0.015% (150 ppm) and notably greater than or equal to 0.005%. The redox of the second glass sheet is preferably greater than or equal to 0.15.

In the present text, the light transmission is calculated from the transmission spectrum between 380 and 780 nm, taking into account the illuminant A and the CIE 1964 standard observer (10°).

The light transmission and the tint of each of the glass sheets are adjusted by virtue of the chemical composition of the glass and the thickness of the glass sheet. The chemical composition of the glass comprises a colorless base, preferably soda-lime-silica base, but other glasses can be used, notably borosilicate or aluminosilicate glasses, as well as a coloring part. The coloring part notably comprises one or more dyes selected from transition metal oxides -notably iron oxides, ferrous and ferric oxides, cobalt oxide, chromium oxide, nickel oxide, rare earth oxides, notably erbium oxide, and selenium.

The first sheet of tinted glass is a glass sheet having for example a light transmission between 50 and 80%, in particular between 60 and 75%. It comprises a coloring part, for example composed of iron oxides, in a total content of between 0.4 and 1.2% by weight, in particular between 0.6 and 1.1% by weight. The glasses obtained are then green, optionally green-yellow or green-blue according to the proportion of ferrous iron. According to other examples, cobalt oxide, selenium and/or erbium oxide are added in order to confer a tint, for example blue or gray.

Better still, the first sheet of tinted, overtinted, glass is a glass sheet having for example a light transmission between 5 and 50%, notably between 8 and 40% and even at most 20%. It comprises a coloring part, for example composed of iron oxides, in a total content of between 1.0 and 2.3 by weight, notably between 1.1 and 2.0% by weight, as well as cobalt and chromium oxides and/or selenium. The coloring part comprises for example the following dyes, in the weighted proportions defined hereinafter: Fe2O3 (total iron) from 1.2 to 2.3%, notably from 1.5 to 2.2%, CoO from 50 to 400 ppm, notably from 200 to 350 ppm, Se from 0 to 35 ppm, notably from 10 to 30 ppm. The redox is preferably between 0.1 and 0.4, in particular between 0.2 and 0.3. Redox is the weight ratio of the content of ferrous iron (expressed as FeO) to the total iron content (expressed as Fe2O3). The glasses obtained are in particular green or gray.

The second glass sheet can be made of organic glass in particular polyurethane (PU), polycarbonate (PC), poly(methyl methacrylate) (PMMA) or poly(vinyl chloride) (PVC).

The second organic glass sheet can be flexible to follow the curvature of the first curved sheet, or the second organic glass sheet can be preformed.

With an organic glass such as PC or PMMA, thermoplastic polyurethane (TPU) or else a crosslinked polymer material is preferable, for more chemical compatibility, to PVB as the lower interlayer. It is also possible to choose thermoplastic or thermoset EVA.

In the present invention, the expression “tempered glass” means thermally tempered glass in the absence of any precision, and preferably glass tempered during an operation of bending the glass.

To guide the light beams, the second mineral glass sheet is preferably clear and even extra-clear or made of clear and even extra-clear organic glass. The second glass sheet has for example a light transmission of at least 85%, or even of at least 90%. It generally does not comprise a coloring part except for inevitable impurities, in particular iron oxides, in a total content of between 0.005 and 0.200% by weight, in particular between 0.010 and 0.150% by weight, or even between 0.030 and 0.120% by weight.

The second glass sheet may (depending on the esthetic rendering, the desired optical effect, the purpose of the glazing, etc.) have for example light transmission TL greater than or equal to 90% for a thickness of 4 mm, and be formed for example from a glass of standard soda-lime composition such as Planilux® from Saint-Gobain Glass, and even an extra-clear glass (for example TL greater than or equal to 91.5% for a thickness of 4 mm), for example a soda-lime-silica glass with less than 0.05% Fe III or Fe2O3 such as the glass Diamant® from Saint-Gobain Glass, or Optiwhite® from Pilkington or B270® from Schott, or another composition described in document WO04/025334.

The glass of the first glass sheet may have undergone chemical or thermal treatment such as hardening, annealing or tempering (for improved mechanical strength in particular) or bending, and is generally obtained using the float process.

The illuminated sunroof can have non-zero light transmission, denoted TL, in all or part of the clear glass area, generally surrounded by a masking layer. For the sunroof, non-zero light transmission TL is preferred and even of at least 0.5% or of at least 2% and of at most 10% and even of at most 8%.

The second glass sheet can alternatively be made of organic glass (preferably rigid, semi-rigid) such as a polymethyl methacrylate (PMMA), preferably with a lamination interlayer (PU)-, a polycarbonate (PC)-preferably with a PVB-lamination interlayer.

It is notably possible to select for the stack: first glass sheet, lamination interlayer, second glass sheet, the following stacks:
mineral glass, PVB (acoustic for example), mineral glass.
mineral glass, lamination interlayer, polycarbonate,

For better thermal insulation, the first glass sheet, or other layer, is tinted and preferably over-tinted,

The light transmission and the tint of each of the glass sheets are adjusted by virtue of the chemical composition of the glass and the thickness of the glass sheet. The chemical composition of the glass comprises a colorless base, preferably soda-lime-silica base, but other glasses can be used, notably borosilicate or aluminosilicate glasses, as well as a coloring part. The coloring part notably comprises one or more dyes selected from transition metal oxides—notably iron oxides, ferrous and ferric oxides, cobalt oxide, chromium oxide, nickel oxide, rare earth oxides, notably erbium oxide, and selenium.

The first sheet of tinted glass is a glass sheet having for example a light transmission between 50 and 80%, in particular between 60 and 75%. It comprises a coloring part, for example composed of iron oxides, in a total content of between 0.4 and 1.2% by weight, in particular between 0.6 and 1.1% by weight. The glasses obtained are then green, optionally green-yellow or green-blue according to the proportion of ferrous iron. According to other examples, cobalt oxide, selenium and/or erbium oxide are added in order to confer a tint, for example blue or gray,

The light rays received by the sunroof are emitted by a light source, preferably included in the glass roof, emitting a light beam in the visible range. The light source is for example a set of light-emitting diodes placed on a first printed circuit support (such as a PCB for printed circuit board), notably a strip, or else a light source which comprises an extracting optical fiber coupled with a primary light source, for example one or more light-emitting diodes.

The light-emitting diodes can be pre-assembled on one or more PCB supports or supports with power supply tracks, and the PCB supports can be attached to other supports, profiles for example. The PCB support is generally thin, notably with a thickness less than or equal to 3 mm, or even 1 mm, or even 0.1 mm or where applicable less than the thickness of a lamination interlayer. Several PCB supports can be provided, particularly if the zones to be illuminated are very far apart. The PCB support can be made of a flexible, dielectric or electrically conductive material (metal such as aluminum, etc.), or be composite, plastic, etc.

The light source can be removable, added, sold separately or in a kit. Preferably, the light source is peripheral, preferably offset from the clear glass area.

According to one embodiment, the light source is monochromatic and emits a light beam comprising electromagnetic waves in the spectrum in a range centered around wavelength λ1 with a spectral bandwidth of 60 nm. Thus, the emitted light beam is of wavelength λ1+30 nm, with λ1+30 nm selected from LB1=532 nm±30 , LB2=480 nm±30 , and LB3=680±30. In particular, LB1 corresponds to green, LB2 corresponds to blue and LB3 corresponds to red. According to another embodiment, the light source is polychromatic and emits a light beam emitting at the first wavelength λ1, at the second wavelength λ2 and at the third wavelength λ3. The wavelength λ1 is selected from LB1=532 nm±30 nm (green), LB2=480 nm±30 nm (blue) or LB3=680 nm±30 nm (red). The wavelength λ2 is distinct from λ1 and is selected from LB1=532 nm±30 nm (green), LB2=480 nm±30 nm (blue) or LB3=680 nm±30 nm (red). The wavelength λ3 is distinct from λ1 and is selected from LB1=532 nm±30 nm (green), LB2=480 nm±30 nm (blue) or LB3=680 nm±30 nm (red). In particular, for all the indices of non-holographic layers, preferably the conditions on the indices are true also at λ2 and λ3.

Preferably, the light source is located on a part of the glazing located inside the trim of the vehicle, the essential function of which is to keep it out of sight from passengers of the vehicle as well as to protect the modules from dust and external influences.

It is also known practice, in particular from document WO 2013/110885, to drill a hole in the sheet of glass and fit the diodes therein. This hole is made near to the extraction means, in particular so as to shorten the optical path followed by the light between the diodes and the extraction means. In this way it is possible to reduce the losses associated with the absorption of the light. The light emitted by the diodes is injected into the sheet of glass via an additional edge face formed by the hole. The light then bounces back and forth between the two main faces of the sheet of glass until it reaches the extraction means. The illuminated zone is inside the passenger compartment, in the case of a roof in particular or to display signage or information for the driver or any other passenger.

The glazing can comprise a plurality of light sources, particularly light-emitting diodes. Of course, several light sources (one or more series of diodes) can be coupled to the second sheet.

Another aspect of the invention relates to a vehicle comprising a sunroof according to any one of the preceding claims.

The invention and its various applications will be better understood from reading the following description and examining the accompanying figures.

### BRIEF DESCRIPTION OF THE FIGURES

The figures are provided for information purposes and are in no way limiting of the invention.

FIG. 1, FIG. 1′, FIG. 2, FIG. 3, FIG. 4, FIG. 5, FIG. 7, FIG. 8, FIG. 9, FIG. 9′, FIG. 10, FIG. 10′, FIG. 11 are embodiments of the sunroof,

FIG. 12 is a depiction of the method of etching a hologram from a microlens array,

FIG. 13 is a depiction of an off-axis Fresnel zone,

FIG. 14 is a figure depicting the intrinsic diffraction efficiency of a hologram of a sunroof, along the 0° direction of observation, and FIG. 14′ is a captioned diagram of FIG. 14 in black and white.

FIG. 15 is a figure depicting the intrinsic diffraction efficiency of the hologram of the same sunroof as FIG. 14, along the +30° direction of observation, and FIG. 15′ is a captioned diagram of FIG. 15 in black and white.

FIG. 16 is a figure depicting the intrinsic diffraction efficiency of the hologram of the same sunroof as FIG. 14, along the −30° direction of observation and FIG. 16′ is a captioned diagram of FIG. 16 in black and white.

FIG. 16b is depicts the angular acceptance and spectral acceptance of a Fresnel zone,

FIG. 17 is a figure depicting the intrinsic diffraction efficiency of the hologram of a sunroof, along the +30° direction of observation and FIG. 17′ is a captioned diagram of FIG. 17 in black and white.

FIG. 18 is a figure depicting the intrinsic diffraction efficiency of the hologram of a sunroof, along the −30° direction of observation and FIG. 18′ is a captioned diagram of FIG. 18 in black and white.

### DETAILED DESCRIPTION

The figures are provided for information purposes and are in no way limiting of the invention. In the following, the same reference on different figures represents the same object. The figures are not to scale.

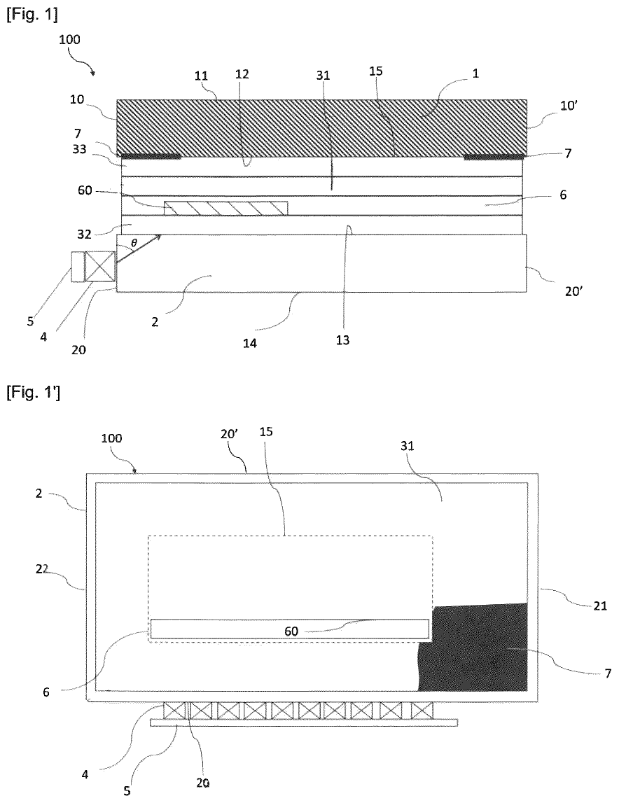

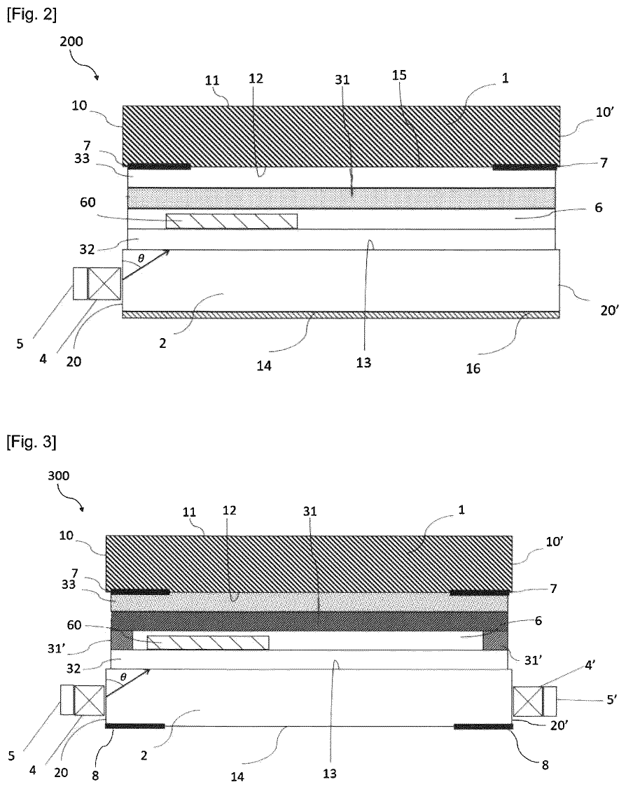

FIG. 1 is an embodiment of the sunroof 100, comprising the first glass sheet 1, tinted, comprising the main face F1 11 facing outwards and the main face F2 12 opposite, the second glass sheet (or alternatively plastic) 2 comprising face F3 13 and face F4 14 opposite, F4 being towards the passenger compartment. The first glass sheet 1 comprises the edge face 10 and the opposite edge face 10′, and the second glass sheet comprises the edge face 20, on the same side as edge face 10, and the opposite edge face 20′ on the same side as edge face 10′. The sunroof 100 comprises a peripheral masking layer 7 on face F2 12, such as an enamel or a black ink. In particular, the inner contour of the masking layer 7 (forming a frame) defines the clear glass area 15.

With reference to FIG. 1, the glazed roof 100 further comprises the holographic layer 6, comprising the first functional zone 60, and which is between the lower intermediate layer 32 (clear, in adhesive contact with face F3 13 of the second sheet 2) and a first upper intermediate layer 31 which is clear for example; there is also a second upper intermediate layer 33 (clear for example) in adhesive contact with face F2 12 of the first sheet 1, notably an interlayer. This second upper intermediate layer 33 is optional notably if the first upper intermediate layer 31 is adhesive (and then in adhesive contact with face F2 12), the interlayer. The sunroof 100 further comprises a light source 4 emitting light rays of angle θ for example, the light injection being carried out in this embodiment by the edge face 20 of the second sheet.

In particular, n₂ is the lowest refractive index at λ1 in the visible range from the refractive indices of the upper intermediate layer(s) 31, 33, notably the interlayer, between the first holographic layer 6 excluded and up to and including the first tinted layer.

In the absence of a tinted upper intermediate layer or in the absence of an upper intermediate layer, n₂ is equal to nᵥ, the refractive index of the first glass sheet 1 (about 1.52 for glass).

Additionally, n₁ is the lowest refractive index at λ1 from the refractive indices of the any lower intermediate layer(s) (in this case for example lower intermediate layer 32), the first functional zone and n₀, with n₂ strictly less than n₁.

In this embodiment, the first upper intermediate layer 31, in contact with the first holographic layer 6, is made of a low-index crosslinked adhesive layer, OCA, and the lower intermediate layer 32 is made of PVB. The second upper intermediate layer 33 is optional, and can be an interlayer in particular PVB or a non-adhesive layer (coating on face F2 12). Additionally, the first glass sheet 1 is herein tinted. In particular, in this embodiment, n₁₁ is the refractive index of the lower intermediate layer 32, n₂₁ is the refractive index of the first upper intermediate layer 31 and n₂₂ is the refractive index of the second upper intermediate layer 33 (furthest from the first holographic layer 6). Thus, in this embodiment, n₁ is equal to the minimum refractive index between n₁₁, n_{H1} and no, the refractive index of the second sheet (about 1.52 for a glass or even higher for a plastic sheet).

Additionally, in this embodiment, n₂ is equal to the minimum refractive index between n₂₁, n₂₂ and nᵥ, which is herein n₂₁ if the low-index OCA is selected. The second upper intermediate layer 33 is optional in particular when the first upper intermediate layer 31 is an adhesive interlayer.

The roof 100 is adapted to receive a light beam in the second glass sheet 2, of light rays injected at λ1 into the second glass sheet 2, with a range θ1 of angles of incidence in the second glass sheet 2. Said light rays are guided in the roof until they reach the first hologram in the first functional zone 60. In particular, the range θ1 of angles is such that arcsin (n₂/n₀)≤θ1≤arcsin (n₁/n₀).

The optical function of said first hologram is selected such that a portion of the rays guided in the roof reach the first hologram and are diffracted and extracted from the roof on the side of face F4 14, the diffracted rays being defined by a range of angles of incidence θ2 on face F4 14, the range of angles θ2 being between-arcsin (1/n₀) and arcsin (1/n₀).

FIG. 1′ is a top view of the sunroof 100 according to FIG. 1, rectangular in shape with the diodes 4 along the longitudinal edge 20 and optionally even along the opposite longitudinal edge 20′ or else the side edges 21, 22.

FIG. 2 is a sunroof 200 which differs from roof 100 in that the first upper intermediate layer 31 of the sunroof 200 is tinted, forming the first tinted layer (the second upper intermediate layer 33 and the glass 1 can be clear or tinted), for example is tinted OCA or alternatively is tinted PVB and then the first lower intermediate layer 32 is of a material different from PVB (refractive index greater than 1.48, film or coating on face F3 13). Additionally, in this embodiment, n₂ is equal to the refractive index n₂₁ (refractive index of said first tinted layer closest to layer 6). The sunroof 200 further comprises an infrared reflective layer 16 (stacked with ITO or other transparent conductive oxide) on face F4 14. The second upper intermediate layer 33 is optional in particular when the first upper intermediate layer 31 is an adhesive interlayer.

FIG. 3 is an embodiment of the sunroof 300 which differs from the roof 100 in that the first upper intermediate layer 31 of the sunroof 300 is made of tinted PVB and the optional second upper intermediate layer 33 of PVB is clear. The lower intermediate layer 32 is made of a material other than PVB (refractive index greater than 1.48, film or coating on face F3 13). The second upper intermediate layer 33 is optional, in particular as the first upper intermediate layer 31 is an adhesive interlayer. It can be particularly useful if it is desired to increase the interlayer thickness and/or an electrically controllable device is inserted between the upper intermediate layers 31 and 33. Additionally, the sunroof 300 comprises a second, peripheral masking layer 8 on face F4 14 of the second glass sheet 2.

The sunroof 300 further increases a second light source 4′ emitting light rays, the light injection also being carried out in this embodiment by the edge face 20′.

The holographic layer 6 does not herein occupy the entire surface of the sunroof and the space 31′ not filled by the holographic layer 6 is herein filled for example by creep of the first upper intermediate layer 31. Creep may or may not be sufficient depending on the thickness of the holographic layer 6. The space 31′ is filled by creep for example or by the addition of material (PVB frame for example) which is not involved in determining index n₂ or index n₁. FIG. 4 is an embodiment of the sunroof 400. It differs from sunroof 100 in that the first glass sheet 1 is colorless, the first upper intermediate layer 31 is tinted, with a refractive index less than nᵥ, for example an interlayer, such as a tinted PVB or EVA or else a tinted OCA, and the lower intermediate layer 32 is absent. The optional second upper intermediate layer 33, which may or may not be adhesive, is tinted or colorless. The holographic layer 6 is a coating on face F3 13 or even on the first upper intermediate layer 31. Optionally, the holographic layer 6 does not occupy the entire surface of the sunroof and the space 31′ not filled by the holographic layer 6 is herein filled for example by PVB that has been subjected to creep or by adding material (PVB frame).

The sunroof 400 further comprises an infrared reflective layer 16 on face F4 14 of the second glass sheet.

FIG. 5 is an embodiment of sunroof 500 which differs from sunroof 100 in that the first glass sheet 1 is colorless, an infrared reflective layer 15′ (a stack based on silver layer(s)) on face F2 12 of the first glass sheet 1 and in that the second upper intermediate layer 33 is tinted.

FIG. 6 is an embodiment of the sunroof 600 which differs from the sunroof 100 in that the first glass sheet 1 is colorless, the second upper intermediate layer 33 is tinted, and in that it comprises the infrared reflective layer 16 on face F4 14 of the second glass sheet 2, and the infrared reflective layer 15′ on face F2 12 of the first glass sheet 1.

With reference to FIG. 6, the upper intermediate layer 33 is made for example of PVB, the first upper intermediate layer 31 is made of OCA, and the lower intermediate layer 31 is made of PVB.

The sunroof 600 comprises a second light source 4′, so that light injection is thus also performed by the edge face 20′ opposite the edge face 20 of the second glass sheet 2.

FIG. 7 is an embodiment of the sunroof 700 which differs from the embodiment of the sunroof 100 in that it does not comprise the second upper intermediate layer, and in that the holographic layer is formed, in this embodiment, of a first part 6 and a second part 6′ herein disjointed.

With reference to FIG. 7, the first part 6 is deposited on a first part 32 of the disjointed lower intermediate layer and comprises a part 60 of the first functional zone. The second part 6′ is deposited on a second part 32′ of the lower intermediate layer and comprises a second part 60′ of the first functional zone. In particular, the parts of the holographic layer and the lower intermediate layer do not extend over the entire surface of the sunroof 700 and the space 32″ not filled by these layers 32, 32′, 6, 6′ is filled by the creep of the first upper intermediate layer 31, for example made of PVB, for example or by adding material. The injection of light through the edge face 20 and/or the opposite edge face 20′ of the longitudinal edges is not shown.

FIG. 8 is an embodiment of the sunroof 800 which differs from the sunroof 100 in that the first upper intermediate layer 31, in particular non-adhesive (forming a holographic layer) comprises a first part 6 and a second part 6′ of the holographic layer herein disjointed. The first part 6 of the holographic layer comprises a first part 60 of the functional zone, and the second part 6′ of the holographic layer comprises a second part 60′ of the functional zone.

The sunroof 800 further comprises the disjointed lower intermediate layer, a first part 32 being under the first part 6 of the holographic layer and a second part 32′ being under the second part 6′ of the holographic layer, the layers 32 and 32′ being surrounded and separated by an intermediate layer 32″ for example PVB interlayer.

In particular, the second upper intermediate layer 33 is made of clear OCA for example.

The sunroof 800 further comprises the infrared reflective layer 16, on face F4 14 of the second glass sheet 2.

According to another embodiment, the injection of light from the light source optically coupled to the second sheet is for example achieved by a wall delimiting a closed hole in the second glass sheet, notably a hole offset from a clear glass area, facing towards an internal masking layer on face F2 or on an interlayer (PVB for example).

FIG. 9 is a depiction of the sunroof 900 which differs from sunroof 600 depicted in FIG. 6, in that it does not comprise the second light source 4′ and in that the light source 4 is embedded within the second glass sheet 2 and notably via one or more through-holes 18 made in said glass sheet 2 and each closed by a metal patch 50, holes close to the edge 20 for example longitudinal. The holes 18 are upstream of the first functional zone 60 facing towards a zone 40 of the layer 6 and below the masking layer 7.

FIG. 9′ depicts the sunroof 900 of FIG. 9 in an alternative and according to a top view, showing the holes 50 herein close to one of the side edges 21, 22.

FIG. 10 is an embodiment of the sunroof 1000 that differs from the previous roof 900 according to FIG. 9 in that light is injected using a light redirecting element 9 located in the lower intermediate layer 32. In this embodiment, the injection of light from the light source 4 into the second glass sheet 2 is performed via the light redirection element 9 on the side of face F3 (or face F4 according to an embodiment not shown), with the light source then facing or offset from face F4 14. The optical coupling is notably direct or achieved by means of an optical system, notably light source and light redirecting element offset from the clear glass area, facing towards the internal masking layer 7. In particular, the light redirection element 9 is for example a reflective prismatic film on the side of face F3 or transparent on the side of face F 4. It is upstream of the first functional zone 60 facing towards a zone 40 of layer 6 and below the masking layer 7.

FIG. 10′ is a top view of the sunroof 1000 according to the embodiment of FIG. 10 showing the extent of the light redirection element 9 herein along one of the longitudinal edges 20, 20′.

FIG. 11 is a sunroof 1100 which is a variant of the sunroof 100 of FIG. 1. In this embodiment, a first holographic layer 6, a second holographic layer 6′ and a third holographic layer 6″ are inserted between the first upper intermediate layer 31 and the lower intermediate layer 32. In particular, between the first holographic layer 6 and the second holographic layer 6′ a preferably adhesive interlayer 34 is inserted, and between the second holographic layer 6′ and the third holographic layer 6″ a preferably adhesive interlayer 36 is inserted.

The first holographic layer 6 comprises the first functional zone 60, the second holographic layer 6′ comprises the second functional zone 61 and the third holographic layer 6″ comprises the third functional zone 62.

### According to one embodiment, each functional zone comprises a thick hologram.

With regard to the first hologram of the first holographic layer, the optical function of said first hologram is selected such that a portion of the rays guided in the roof, in range θ1, reaches the first hologram and is diffracted and extracted from the roof on the side of face F4 14 of the sunroof.

Preferably, the first hologram is a diffraction grating, preferably sinusoidal. The diffraction grating is preferably a constant-pitch diffraction grating or a variable-pitch diffraction grating.

For example, the first hologram is a set of off-axis Fresnel zones, notably obtained from an array of microlenses and in particular obtained from the recording of the field transmitted by an array (or matrix) of microlenses. In fact, the hologram of a microlens is a Fresnel zone. In this example, the first hologram thus comprises a plurality of elementary holograms, each elementary hologram being obtained from a microlens and corresponding to a Fresnel zone. The use of the hologram of a microlens array is advantageous because, in order to obtain homogeneous illumination when the roof is viewed in a given direction and notably at 0°, the rays must be extracted within a cone, which is advantageously achieved by a microlens array or, equivalently, a Fresnel zone array.

The second and third holograms are manufactured similar to the first hologram.

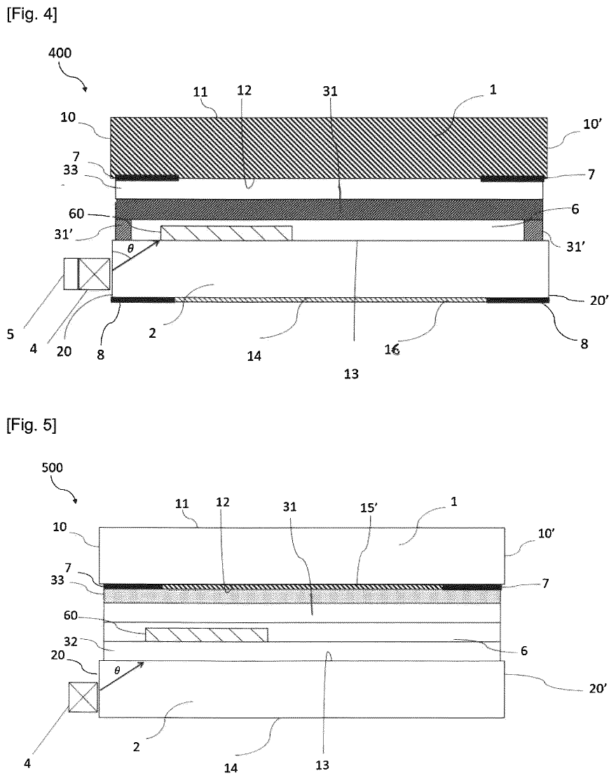

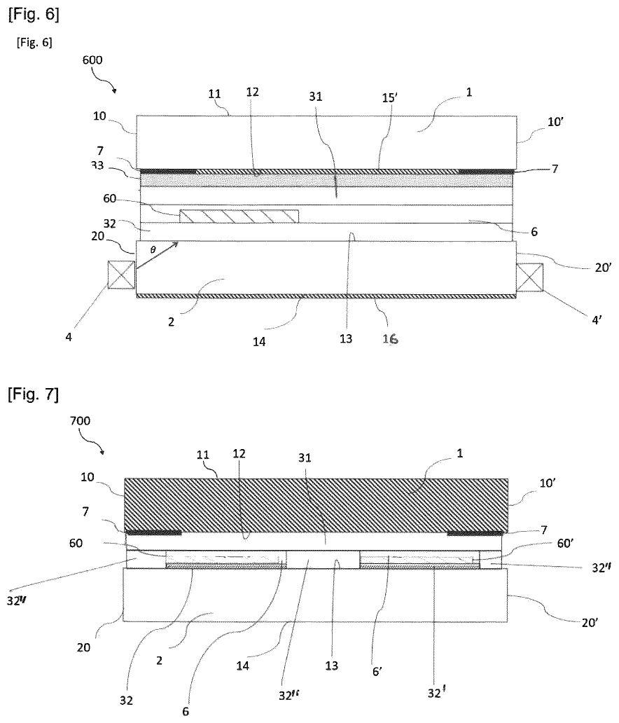

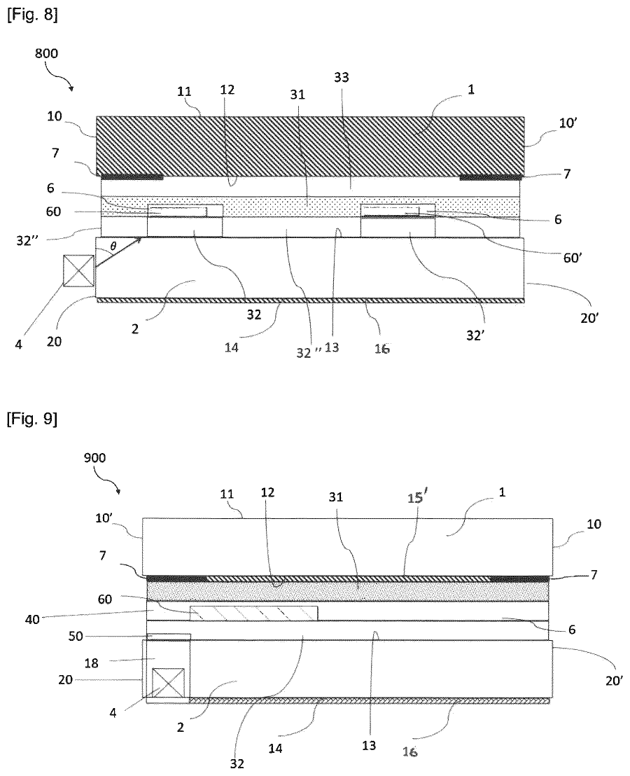

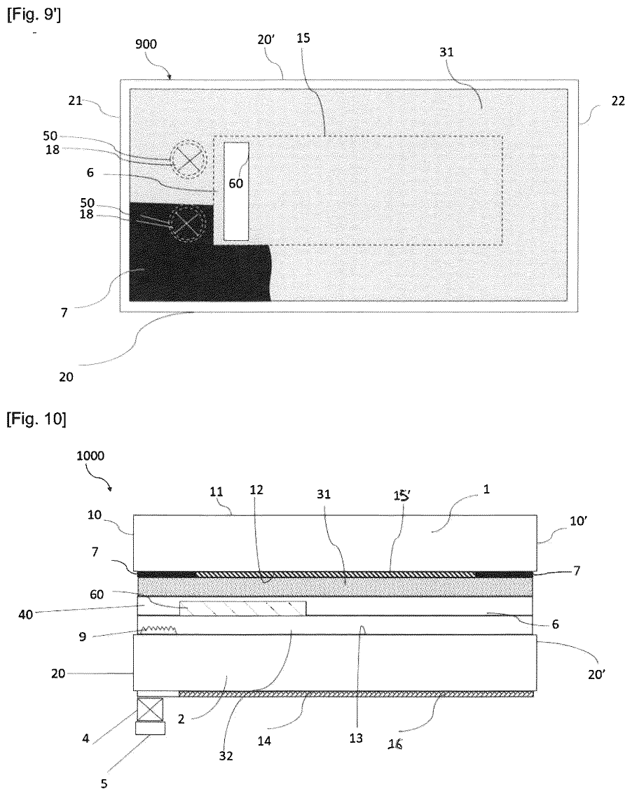

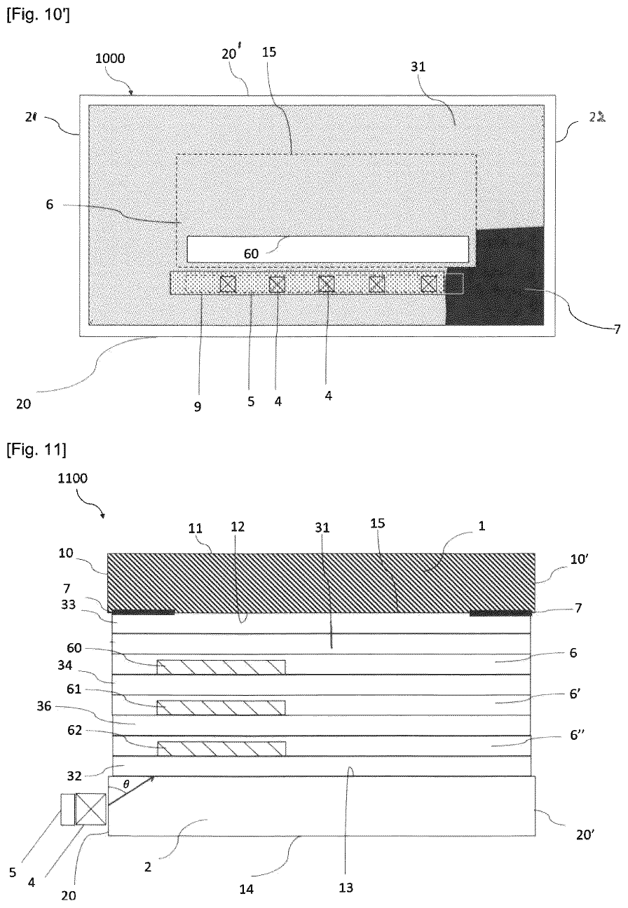

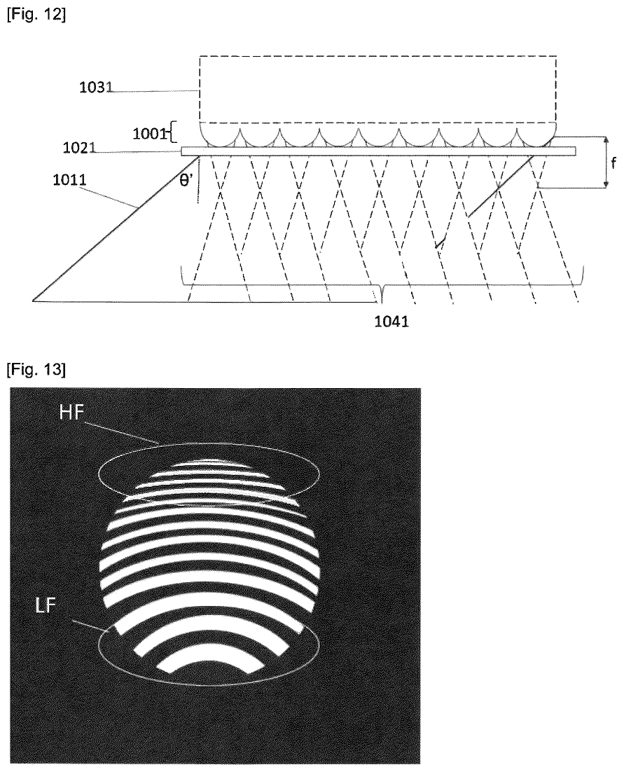

FIG. 12 is a figure depicting the recording of a hologram from a microlens array 1001.

In the recording process, an assembly 102 formed of a glass substrate to which a holographic material is attached is used.

In particular, the assembly 1021 faces the convex part of each microlens of the microlens array 1001.

When recording a hologram, a planar signal beam 1031 illuminates the planar side of the microlens array 100′ which generates a set of spherical waves 1041 on the convex side of the microlens array 100′.

Additionally, a reference beam 1011 comprising plane waves, illuminates the convex face of each microlens of the microlens array 1001. The reference beam 1011 is inclined at an angle θ′ with respect to the normal to the assembly 1021.

The holographic material of the assembly 1021 records the interferences between the set of spherical waves 104 generated by the microlens array 1001 and the reference beam 101, the interference pattern obtained being a set of Fresnel zones, each Fresnel zone corresponding to a microlens.

FIG. 13 is an example of an off-axis Fresnel zone, also known as a “flat zone”.

In particular, according to the previous description of the recording of a hologram of a microlens, a Fresnel zone, denoted Z, can be modeled by the addition of a spherical wave S and an inclined plane wave P.

Thus, the Fresnel zone is defined by the following formula: Z=S+P, S and P being two optical fields, with

$$S = S 0 * {e}^{i \frac{2 π}{λ} \sqrt{{R}^{2} + {x}^{2} + y}} and P = P 0 * {e}^{i \frac{2 π}{λ} sin ( {θ}^{′} )} .$$

In particular, SO being a multiplicative factor of the same unit as S, and PO being a multiplicative factor of the same unit as P.

With R the distance between the point source and the hologram and θ′ the angle of the reference wave with respect to the optical axis.

Fresnel zones can be considered to be gratings whose period (or pitch) varies continuously. Thus, each Fresnel zone comprises a low-frequency LF side and a high-frequency HF side as shown in FIG. 13.

As previously specified, the rays diffracted and extracted from the roof, by the first hologram, are defined by a range of angles of incidence θ2 on face F4, θ2 being less than θ1, and defined as between-arcsin (1/n₀)≤θ2 ≤arcsin (1/n₀). In particular, the value 1 in the arcsin formula (1/n₀) represents the refractive index of air.

The optical function of said first hologram is further selected such that, from the light rays diffracted by the hologram, more than 10% of the rays are diffracted according to the angle of incidence range θ2, or even more than 50%, or even 70%.

When the guided angular domain in the hologram is restricted, it takes several bounces before each point in the hologram can see several guided angles. For a monochromatic beam, the different zones receiving light do not overlap. Thus, light is extracted disjointedly until a continuous light is obtained. Continuous light extraction is achieved after a number k of bounces, k being greater than or equal to 1. The number k of bounces is calculated from a distance hₖ of one end of the holographic layer with respect to the edge face of the sunroof, with hₖ greater than or equal to (2k+1)*d*(tan θₖ₁−tan θₖ₂), where d is the thickness through which the light passes from its injection into the second glass sheet and up to the layer of index n₂. For example, d can be equal to the thickness of the second glass layer, the lower intermediate layers (where applicable) and the holographic layer. Additionally, θₖ₁ is the angle of a first guided ray, and θₖ₂ is the angle of a second guided ray.

According to the embodiment wherein the light source is polychromatic, the first so-called multi-band hologram also diffracts at the second wavelength λ2, the first functional zone having a refractive index n_{H2} at λ2 or even also diffracts at the third wavelength λ3, the first functional zone having a refractive index n_{H3} at λ3 or in that the roof comprises a second hologram diffracting at λ2 between the first hologram and face F3.

Optionally, the sunroof comprises a second holographic layer having a second functional zone having a refractive index n_{H2} at λ2 and optionally the roof comprises a third hologram diffracting at λ3, between the second hologram and face F3, with a third holographic layer with a third functional zone having a refractive index n_{H3} at λ2.

In other words, the holographic layer comprises either a holographic layer comprising a multi-band hologram diffracting at λ1, λ2, λ3 or the roof comprises second and third holograms respectively diffracting at λ2, λ3 and λ0 is in a spectral band (in particular LB2) including the value of the medium from λ1, λ2, λ3, and the second and third holograms have distinct inscription wavelengths in the visible range λ′0 and λ″0, distinct from AO in a spectral band including a distinct value of the medium from λ1, λ2, λ3 (in particular LB1 and LB3).

When the second functional zone is identical to the first functional zone, the first hologram and the second hologram are multiplexed, resulting in a linear combination of the optical function of the first hologram and the optical function of the second hologram. The first hologram can alternatively diffract over two distinct wavelength ranges.

In particular, n₂ₐ is the refractive index, the lowest at λ2 in the visible range:
a) In the case of a second functional zone, from the refractive indices at λ2 of the lower intermediate layer(s) above (moving towards face F2) the second functional zone, the first functional zone, the upper intermediate layer(s) and up to and including the first tinted layer,
b) or in the case of a first multi-band hologram, from the refractive indices of the upper intermediate layer(s) (notably the interlayer) between the first holographic layer excluded and up to and including the first tinted layer
c) or in the absence of a tinted upper intermediate layer or upper intermediate layer, n₂ₐ being equal to nᵥₐ where nᵥₐ is the refractive index at λ2 in the visible range of the first sheet
i) n₁ₐ is the lowest refractive index at λ2 from the refractive indices of the any lower intermediate layer(s) beneath the second functional zone (towards face F3), the index n_{H2} of the second functional zone, and n₀ₐ which is the refractive index at λ2 in the visible range of the second glass sheet.
j) or in the case of a first multi-band hologram, n₁ₐ is the lowest refractive index at λ2 of the refractive indices of the any lower intermediate layer(s) (below the first functional zone), the index n_{H2} of the first functional zone, and n₀ₐ which is the refractive index at λ2 in the visible range of the second sheet The optical function of said second hologram or of first multi-band hologram is selected such that a portion of light rays injected at λ2 into the second glass sheet, guided in the roof, in particular in range θ1, reaches the second hologram or the first multi-band hologram and is diffracted and extracted from the roof on the side of face F4 in all or part of the range of angles of incidence θ02 on face F4, therefore in the second glass sheet, and lying between −arcsin (1/n₀ₐ) and arcsin (1/n₀ₐ).

Optionally, n_{2b} is defined as the lowest refractive index at λ3 in the visible range:
a) in the case of a third functional zone, from the refractive indices at λ3 of the lower intermediate layer(s) above (towards face F2) the third functional zone (including the second functional zone), the first functional zone, the upper intermediate layer(s) and up to and including the first tinted layer,
b) or in the case of a first multi-band hologram, from the refractive indices of the upper intermediate layer(s) (notably the interlayer) between the first holographic layer excluded and up to and including the first tinted layer
c) or in the absence of a tinted upper intermediate layer or upper intermediate layer, n_{2b} being equal to n_{vb} where n_{vb} is the refractive index at λ3 in the visible range of the first sheet

In particular, n_{1b} is the lowest refractive index at λ3 from the refractive indices of the any lower intermediate layer(s) below the third functional zone (towards face F3), the index n_{H3} of the third functional zone, and nob which is the refractive index at λ3 in the visible range of the second sheet.

In particular, the optical function of said third hologram or of the first multi-band hologram being selected such that a portion of light rays injected at λ3 into the second glass sheet, guided in the roof, in particular in range θ1, reaches the third hologram or the first multi-band hologram and is diffracted and extracted from the roof on the side of face F4 in all or part of the range of angles of incidence θ2 on face F4, in the second glass sheet, and lying between-arcsin (1/n_{0b}) and arcsin (1/n_{0b}).

According to the previous embodiment, for a given direction of observation in range θ2:
the first hologram diffracts at λ1 and has a maximum diffraction efficiency in a first sub-range of θ1a with a width of at least 1°,
the second hologram or the first multi-band hologram diffracting at λ2 has a maximum diffraction efficiency in a second sub-range of θ1b with a width of at least 1° with partial or disjoint overlap of θ1a
the optional third hologram or the first multi-band hologram (or even the second multi-band hologram), diffracting at λ3, having a maximum diffraction efficiency in a third sub-range of θ1c with a width of at least 1° with partial or disjoint overlap with the first and second sub-ranges θ1a and θ2a. In particular, all the sub-ranges θ1a, θ1b, θ1c preferably cover at least 60%, 80% of 01.

Additionally, n₁ₐ is the lowest refractive index at λ2 from the refractive indices of the any lower intermediate layer(s), of the first functional zone and n₀ₐ.

The third functional zone can be distinct from the first functional zone and distinct from the second functional zone or identical to the first functional zone and identical to the second functional zone.

When the third functional zone is distinct from the first functional zone and the second functional zone, the first hologram, the second hologram and the third hologram are stacked, with the third hologram being in a lower intermediate layer comprising said third functional zone.

When the third functional zone is identical to the first functional zone and to the second functional zone, the first hologram, the second hologram and the third hologram are multiplexed, resulting in a linear combination of the optical function of the first hologram, of the optical function of the second hologram and of the optical function of the third hologram.

In particular, the optical function of said third hologram being selected such that a portion of the rays guided in the roof, in range θ1, reaches the third hologram and is diffracted and extracted from the roof on the side of face F4 in all or part of the range of angles of incidence θ2 on face F4.

In particular, the maximum difference between the refractive indices n_{H1}, n_{H2}, n_{H3} for LB1, LB2 and LB3 is at most 0.2 and even at most 0.1.

Consider an embodiment wherein the sunroof (not shown) comprises the first sheet of tinted glass, the second glass sheet with index n₀=1.52, the holographic photopolymer layer and the first upper PVB intermediate layer with refractive index n21=1.485.

In this embodiment, the first hologram of the holographic layer is produced from a matrix of microlenses and therefore corresponds to a set of off-axis Fresnel zones.

In particular, the holographic layer has the following indices: n_{H1}=1.481 for λ1=LB3, which corresponds to red, n_{H2}=1.491 for λ2=LB1, which corresponds to green and n_{H3}=1.497 for λ3=LB2, which corresponds to blue.

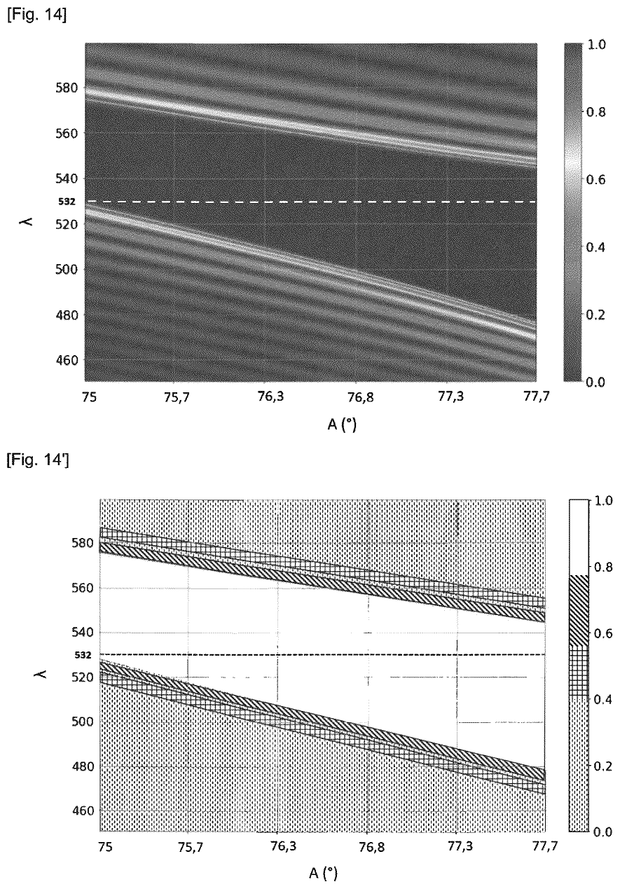

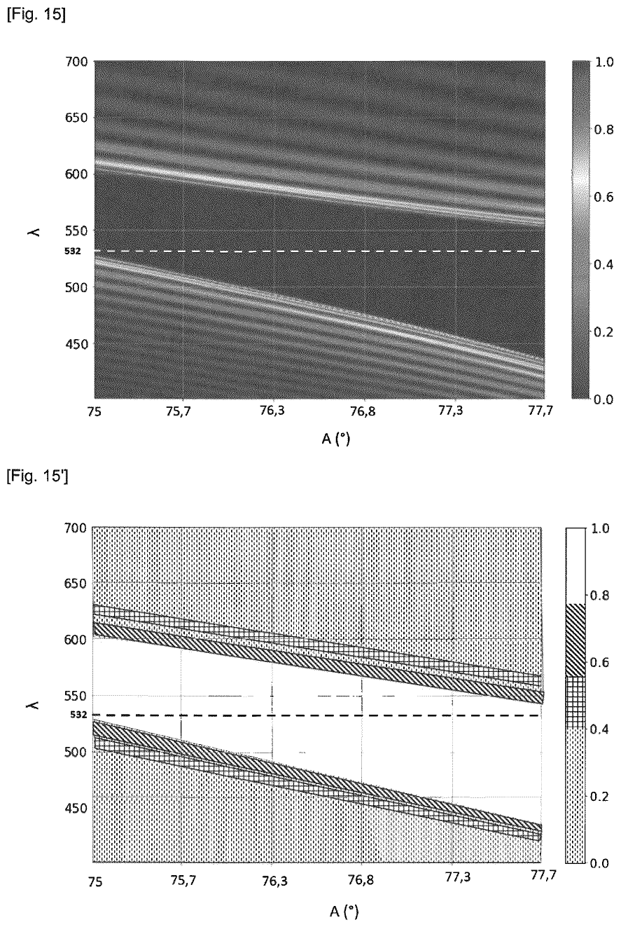

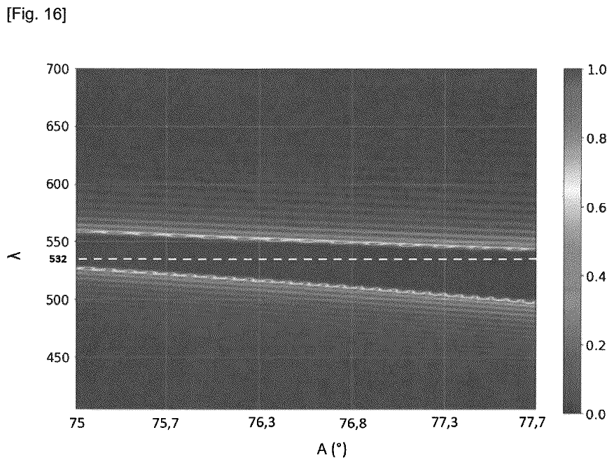

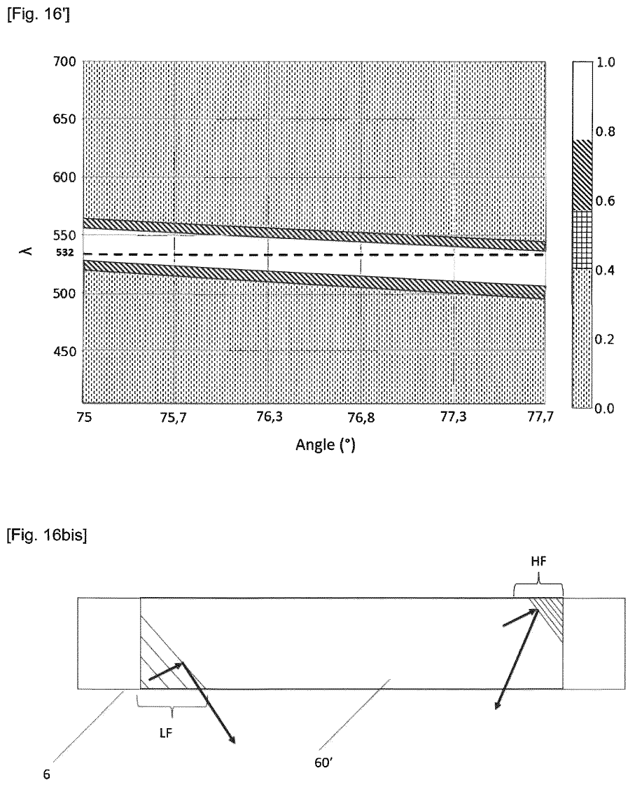

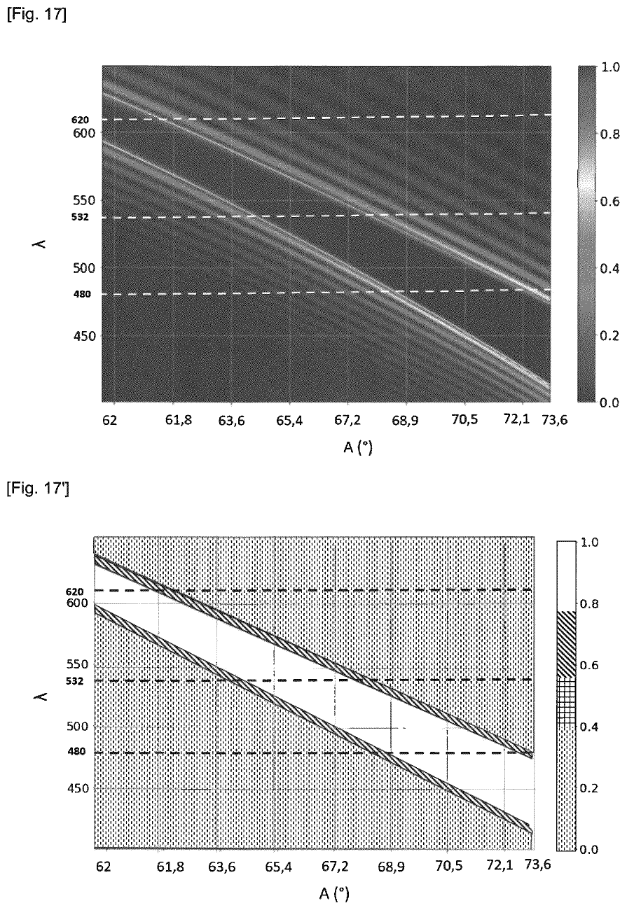

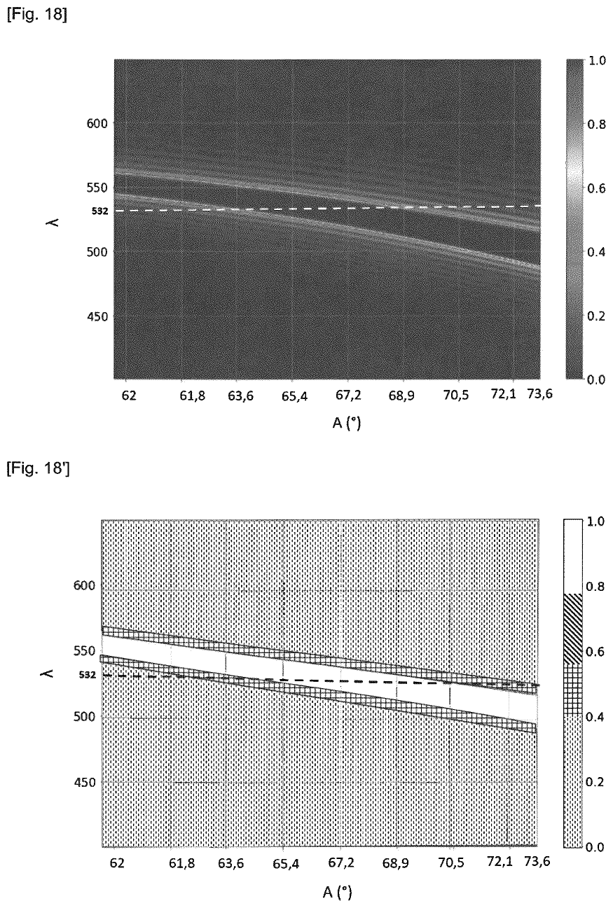

FIG. 14, FIG. 14′, FIG. 15, FIG. 15′, FIG. 16, FIG. 16′, FIG. 17, FIG. 17′ and FIG. 18, FIG. 18′ each depict the intrinsic diffraction efficiency of the first hologram of the sunroof for several embodiments and several directions of observation, and wherein the ordinates represent the wavelength A of the light rays in the glazing, A being in nanometers, and wherein the abscissae represent the angle A of the rays in the sunroof, A being in degrees. The intrinsic efficiency is between 0 and 1.

FIG. 14 depicts the intrinsic diffraction efficiency of the first hologram of the sunroof in the previous embodiment based on the wavelength and angles of the rays guided in the sunroof, for a 0° direction of observation. FIG. 14′ depicts FIG. 14 in black and white with captions.

Light rays of wavelength λ1=LB3 are not guided in the roof.

In particular, guided light rays of wavelength λ2=LB1 (green) have an angle of incidence in the second glass sheet of between 75° and 77.7°. For this wavelength, continuous light extraction is obtained from n=5 bounces of the guided rays, from a distance h₅=4.8 cm.

Additionally, the guided light rays of wavelength λ3=LB2 (blue) have an angle of incidence in the second glass sheet of between 77.6° and 77.7°. At this wavelength, continuous light extraction is obtained from n=2 bounces of the guided rays, from a length h₂=1.9 cm of the holographic layer.

With reference to [FIG. 14], for white light, the hologram extracts only guided rays having a wavelength between 480 and 580 nm approximately.

With reference to [FIG. 14], for incident rays of wavelength λ2=LB1=532 nm, said first hologram has a theoretical diffraction efficiency equal to 1, or equivalently 100% for all guided angles, in the direction of observation at θ2=0°. In other words, for a light beam with a wavelength equal to 532 nm, all guided angles are extracted via face F4. Additionally, for guided beams having a wavelength between 530 nm and 540 nm, all guided angles are extracted by the first hologram.

With reference to FIG. 14, when the first hologram diffracts selectively at λ3=LB2=480 nm, said hologram has a diffraction efficiency greater than or equal to 0.8, in the direction of observation at θ2=0° for guided angles whose angle of incidence is between 77.6° and 77.7°.

[FIG. 15] shows the intrinsic diffraction efficiency of the first hologram of the roof cited in the previous embodiment, in a direction of observation at θ2=+30° which corresponds to the guided rays diffracted by the low spatial frequency side of the Fresnel zones, presented previously. FIG. 15′ depicts FIG. 15 in black and white with captions.

With reference to FIG. 15, for incident rays of wavelength λ2=LB1=532 nm, said first hologram has a diffraction efficiency equal to 1, or equivalently 100% for all guided angles, in the direction of observation at θ2=+30°. In other words, for a light beam with a wavelength equal to 532 nm, all guided angles are extracted via face F4. Additionally, for guided beams having a wavelength between 525 nm and 555 nm, all guided angles are extracted by the first hologram.

With reference to FIG. 15, when the first hologram diffracts selectively at λ3=LB2=480 nm, said hologram has a theoretical diffraction efficiency greater than or equal to 0.8, in the direction of observation at θ2=+30° for guided angles whose angle of incidence is between 77.2°and 77.7°.

[FIG. 16] shows the intrinsic diffraction efficiency of the first hologram of the roof cited in the previous embodiment, in a direction of observation at θ2=−30°, which corresponds to the guided rays diffracted by the high spatial frequency side of the Fresnel zones, presented previously. FIG. 16′ depicts FIG. 16 in black and white with captions.

With reference to FIG. 16, for incident rays of wavelength λ2=LB1=532 nm, said first hologram has a diffraction efficiency equal to 1, or equivalently 100% for all guided angles, in the direction of observation at θ2=−30 °. In other words, for a light beam with a wavelength equal to 532 nm, all guided angles are extracted via face F4. Additionally, for guided beams having a wavelength between 530 nm and 552 nm, all guided angles are extracted by the first hologram.

Thus, the spectral width over which all guided angles are extracted is a width less than about 15 nm. Outside this spectral band, the diffraction efficiency is between 0 and 0.1.

With reference to FIG. 15 and FIG. 16, rays diffracted by the low-frequency side of Fresnel zones result in wider spectral coverage and lower angular coverage and rays diffracted by the high-frequency side of Fresnel zones result in narrower spectral coverage and wider angular coverage.

FIG. 16b is depicts the low-frequency side diffraction BF and the high-frequency side diffraction ZF of a Fresnel zone and their spectral coverage, as described in the previous paragraph.

Consider a second embodiment wherein the sunroof (not shown) comprises the first sheet of tinted glass, the second sheet of glass with index n₀=1.52, the holographic photopolymer coating and the first upper intermediate layer of OCA with refractive index n₂₁=1.3

In this second embodiment, the first hologram of the holographic layer is produced from a matrix of microlenses and therefore corresponds to a set of off-axis Fresnel zones.

In particular, the holographic layer comprises index modulation, with n_{H1}=1.481 for λ1=LB3, which corresponds to red, n_{H2}=1.491 for λ2=LB1, which corresponds to green and n_{H3}=1.497 for λ3=LB2, which corresponds to blue.

FIG. 17 shows the intrinsic diffraction efficiency of the first hologram of the roof cited in the second embodiment, in a direction of observation at θ2=+30°, which corresponds to the guided rays diffracted by the low spatial frequency side of the Fresnel zones, presented previously. FIG. 17′ depicts FIG. 17 in black and white with captions.

With reference to FIG. 17 for incident rays of wavelength λ2=LB1=532 nm, said first hologram has a theoretical intrinsic diffraction efficiency equal to 1, or equivalently 100% for guided angles having an incident angle between about 67.5° and 71.8°, in the direction of observation at θ2=+30°.

With reference to FIG. 17, when the first hologram diffracts selectively at λ3=LB2=480 nm, said hologram has a theoretical intrinsic diffraction efficiency equal to 1, in the direction of observation at λ2=+30° for guided rays whose angle of incidence is between about 70.5° and 73.6°.

With reference to FIG. 17, when the first hologram diffracts selectively at λ1=620 nm, said hologram has a theoretical intrinsic diffraction efficiency equal to 1, in the direction of observation λ2=+30° for guided rays whose angle of incidence is between about 51.9° and 61.6°.

FIG. 18 shows the intrinsic diffraction efficiency of the first hologram of the roof cited in the second embodiment, in a direction of observation at θ2=−30°, which corresponds to the guided rays diffracted by the high spatial frequency side of the Fresnel zones, presented previously. FIG. 18′ depicts FIG. 18 in black and white with captions.

With reference to FIG. 18, for incident rays of wavelength λ2=LB1=532 nm, said first hologram has a theoretical intrinsic diffraction efficiency equal to 1, or equivalently 100% for guided angles having an incident angle between about 63.6° and 68.9°, in the direction of observation at θ2=−30 °.

With reference to FIG. 18, virtually no red or blue rays are diffracted, the diffraction efficiency being less than 0.05.

FIGS. 14 and 18 show the domains of feasibility of obtaining an effective hologram at one or more wavelengths.

1. A laminated vehicle sunroof comprising:
a first outer sheet of transparent mineral glass having a first main face and a second opposite main face, known as face F2, with a refractive index nᵥ at a first wavelength λ1 in the visible range,
a second, inner, glass sheet of transparent organic or mineral glass, with a refractive index n₀ at λ1, having a third main face and an opposite fourth main face,
between the second main face and the third main face, a dielectric lamination interlayer of polymer material, comprising at least one lamination interlayer,
the sunroof comprising, between the second main face and the third main face, in this order moving away from the second main face:
one or more transparent, dielectric upper intermediate layers with given refractive indices in the visible range,
the first outer sheet being tinted and/or from the upper intermediate layer a first layer being tinted,
when several upper intermediate layers are tinted, the first tinted layer is the tinted layer closest to the third main face,
a first transparent dielectric holographic layer comprising a first functional zone with a first thick hologram, diffracting at λ1, the first functional zone having a refractive index n_{H1} at λ1,
n₂ being the lowest refractive index at λ1 in the visible range:
a) from the refractive indices of the upper intermediate layer(s) between the first holographic layer excluded and up to and including the first tinted layer,
b) or in the absence of a tinted upper intermediate layer or in the absence of an upper intermediate layer n₂ being equal to nᵥ,
the sunroof being adapted to receive a light beam in the second glass sheet, light rays injected at λ1 into the second glass sheet, with a range θ1 of angles of incidence in the second glass sheet, being guided in the sunroof until reaching the first hologram and with θ1 such that arcsin (n₂/n₀)≤θ01 ≤arcsin (n₁/n₀),
the optical function of said first hologram being selected such that a portion of the rays guided in the sunroof reach the first hologram and are diffracted and extracted from the sunroof on the side of the fourth main face F4, the diffracted rays being defined by a range of angles of incidence θ2 on the fourth main face F4 and lying between-arcsin (1/n₀) and arcsin (1/n₀).

2. The sunroof according to claim 1, wherein the first hologram is reflective.

3. The sunroof according to claim 1 wherein the first holographic layer is a coating or the first holographic layer is a film.

4. The sunroof according to claim 17 wherein at least one lower intermediate layer is an adhesive layer in contact with the first holographic layer and/or at least one upper intermediate layer is an adhesive layer in contact with the first holographic layer.

5. The sunroof according to claim 1 wherein:
n₀ is between 1.5 and 1.62 at λ1,
n₂ is less than or equal to 1.48 at λ1,
nᵥ is between 1.5 and 1.55 at λ1.

6. The sunroof according to claim 1, wherein n₂ is less than or equal to 1.45 with nᵥ greater than n₂.

7. The sunroof according to claim 1, wherein n₁ is greater than or equal to 1.48 and n₁ is greater than n₀, n₁ is less than or equal to n_{H1}.

8. The sunroof according to claim 1, wherein the first hologram is a sinusoidal diffraction grating.

9. The sunroof according to claim 1, wherein the first hologram is a set of off-axis Fresnel zones.

10. The sunroof according to claim 1, comprising a light source optically coupled to the second inner glass sheet λ1 is selected in a first range LB1 from 450 nm up to 510 nm excluded or in a second range LB2 from 510 nm up to 560 nm excluded, or in a third range LB3 from 560 to 650 nm.

11. The sunroof according to claim 10, wherein an upper intermediate layer is an interlayer with an index nᵢ equal to 1.48 in the visible range, and wherein λ1 is equal to in the first range LB2 or LB1,

12. The sunroof according to claim 17 any comprises comprising a polychromatic light source, optically coupled to the second inner glass sheet, the polychromatic light source emitting:
at said first wavelength λ1 selected from within a first range which is in a first range LB1 from 450 nm up to 510 nm excluded or in a second range LB2 from 510 nm up to 560 nm excluded, or in a third range LB3 from 560 nm to 650 nm,
at a second main wavelength λ2 distinct from λ1 selected in a second range distinct from the first range and which is in the first, second or third ranges LB1, LB2, LB3.

13. The sunroof according to claim 12, wherein the first so-called multi-band hologram also diffracts at the second wavelength λ2, the first functional zone having a refractive index n_{H2} at λ2 or also diffracts at the third wavelength λ3, the first functional zone having a refractive index n_{H3} at λ3 or the sunroof comprises a second hologram diffracting at λ2 between the first hologram and the third main face, with a second holographic layer having a second functional zone having a refractive index n_{H2} at λ2 and optionally the sunroof comprises a third hologram diffracting at λ3, between the second hologram and the third main face, with a third holographic layer with a third functional zone having a refractive index n_{H3} at λ3,
n₂ₐ being the lowest refractive index at λ2 in the visible range:
a) in the case of a second functional zone, from the refractive indices at λ2 of the lower intermediate layer(s) above the second functional zone, the first functional zone, the upper intermediate layer(s) and up to and including the first tinted layer,
b) or in the case of a first multi-band hologram, from the refractive indices of the upper intermediate layer(s) between the first excluded holographic layer and up to and including the first tinted layer,
c) or in the absence of a tinted upper intermediate layer or upper intermediate layer, n₂ₐ being equal to nᵥₐ, where nᵥₐ is the refractive index at λ2 in the visible range of the first sheet, and
i) n₁ₐ being the lowest refractive index at λ2 from the refractive indices of the any lower intermediate layer(s) below the second functional zone, the index n_{H2} of the second functional zone, and n₀ₐ which is the refractive index at λ2 in the visible range of the second sheet,
j) or in the case of a first multi-band hologram, n₁ₐ being the lowest refractive index at λ2 of the refractive indices of any lower intermediate layer(s) the index n_{H2} of the first functional zone, and n₀ₐ which is the refractive index at λ2 in the visible range of the second sheet,
the optical function of said second hologram or of said first multi-band hologram being selected such that a portion of light rays injected at λ2 into the second glass sheet, guided in the sunroof, reaches the second hologram or the first multi-band hologram and is diffracted and extracted from the sunroof on the side of face F4 in all or part of the range of angles of incidence θ2 on face F4, and comprised between −arcsin (1/n₀ₐ) and arcsin (1/n₀ₐ),
and optionally, n_{2b} being the lowest refractive index at λ3 in the visible range:
a′) in the case of a third functional zone, from the refractive indices at λ3 of the lower intermediate layer(s) above the third functional zone, the first functional zone, the upper intermediate layer(s) and up to and including the first tinted layer,
b′) or in the case of a first multi-band hologram, from the refractive indices of the upper intermediate layer(s) between the first holographic layer excluded and up to and including the first tinted layer,
c′) or in the absence of a tinted upper intermediate layer or upper intermediate layer, n_{2b} being equal to n_{vb} where n_{vb} is the refractive index at λ3 in the visible range of the first sheet, and
n_{1b} being the lowest refractive index at λ3 from the refractive indices of the any lower intermediate layer(s) below the third functional zone, the index n_{H3} of the third functional zone, and nob which is the refractive index at λ3 in the visible range of the second sheet,
the optical function of said third hologram or of said first multi-band hologram being selected such that a portion of light rays injected at λ3 into the second glass sheet, guided in the sunroof, reaches the third hologram or the first multi-band hologram and is diffracted and extracted from the sunroof on the side of face F4 in all or part of the range of angles of incidence θ2 on face F4, and comprised between-arcsin (1/n_{0b}) and arcsin (1/n_{0b}),
for a given direction of observation in range θ2:
the first hologram diffracting at λ1 having a maximum diffraction efficiency in a first sub-range of θ1a with a width of at least 1°,
the second hologram or the first multi-band hologram diffracting at λ2 having a maximum diffraction efficiency in a second sub-range of θ1b with a width of at least 1° with partial or disjoint overlap of θ1a,
the optional third hologram or the first multi-band hologram, diffracting at λ3, having a maximum diffraction efficiency in a third sub-range of θ1c with a width of at least 1° with partial or disjoint overlap with first and second sub-ranges θ1a and θ2a.

14. The sunroof according to claim 1 comprising:
a first upper intermediate layer, the interlayer, of crosslinked adhesive material, with a refractive index equal to n₂,
a first lower intermediate layer, the interlayer, with a refractive index of at least 1.48 at λ1,
a second mineral glass sheet.

15. The sunroof according to claim 1 wherein the first holographic layer is a photopolymer, the first functional zone has an index modulation dn about a refractive index n_{H0} at an inscription wavelength in the visible range λ0.

16. The sunroof according to claim 1, wherein the refractive index nᵥ is greater than or equal to 1.5.

17. The sunroof according to claim 1, comprising, between the first functional zone and the third main face, one or more lower transparent, dielectric intermediate layers, n₁ being the lowest refractive index at λ1 from the refractive indices of any lower intermediate layer(s), of the first functional zone and n₀, with n₂<n₁.

18. The sunroof according to claim 3, wherein first holographic layer is a coating on the third main face.

19. The sunroof according to claim 5, wherein n₂ is less than or equal to 1.45 and at least 1.3 at λ1.

20. The sunroof according to claim 10, wherein the light source is a monochromatic light source.
